(19) United States
(12) Patent Application Publication
(10) Pub. No.: US 2024/0152838 A1
(43) Pub. Date: May 9, 2024

(54) NONDESTRUCTIVE TEST EVALUATION DATA MANAGEMENT DEVICE AND NONDESTRUCTIVE TEST EVALUATION DATA MANAGEMENT METHOD

(71) Applicant: JGC CORPORATION, Kanagawa (JP)

(72) Inventors: Shohei NAKAMURA, Kanagawa (JP); Nobutaka TANAKA, Kanagawa (JP); Yuichi HIRATSUKA, Kanagawa (JP)

(73) Assignee: JGC CORPORATION, Kanagawa (JP)

(21) Appl. No.: 18/280,669

(22) PCT Filed: Jun. 7, 2021
(86) PCT No.: PCT/JP2021/021509

§ 371 Date: Sep. 6, 2023

(51) Int. Cl. G06Q 10/0631

(52) U.S. Cl. CPC G06Q 10/06316

(57) ABSTRACT

To provide a non-destructive inspection judgment data management device with which the workability of a judge is improved and a burden on a client of a judgment task is reduced, the device includes: a first database registration module which registers image data of a weld point in a first database; a second database registration module which registers judge information on a judge undertaking a judgment task of judging whether a weld defect is present at the weld point based on the image data, in a second database; and an access control module which allows, based on contract information indicating a contract for the judgment task has been established with the judge selected as a contractor of the judgment task among the judges registered in the second database, the contractor to access the image data related to the judgment task in the image data registered in the first database via Internet.

### TECHNICAL FIELD

The present invention relates to a non-destructive inspection judgment data management device and a non-destructive inspection judgment data management method for achieving business matching between a client who requests a judgment task of judging whether there is a weld defect based on image data related to a non-destructive inspection of a weld point and a judge (a contractor) who undertakes the judgment task.

### BACKGROUND ART

Hitherto, as one method of non-destructive inspection at a weld point, a judgment task is performed in which a judge (a qualified person) visually checks a film or the like on which an image of the weld point is captured by radiation to judge whether there is a weld defect. For example, in Patent Literature 1, there is disclosed a radiographic inspection device that applies radiation to a weld point and exposes a film with transmitted radiation.

### CITATION LIST

### Patent Literature

[PTL 1] JP 7-16152 U

### SUMMARY OF INVENTION

### Technical Problem

The radiographic inspection device as disclosed in Patent Literature 1 uses a physical medium such as a film, and hence management tasks including development, transfer, storage, and recording of films, for example, are complicated. Therefore, in a welding site at which a large number of weld points are provided and a welding process is performed at each weld point, the work efficiency and the work environment of the judge are bad, which may cause a backlog. Further, in the case in which the judge is stationed in a welding site and performs a judgment task there, securing the judge and the cost of stationing the judge impose a heavy burden on the client (for example, a prime contractor or a sub-contractor of the welding site) who requests the judgment task of the judge.

Meanwhile, in recent years, a radiographic inspection device is being developed which uses computed radiography (CR) and an electronic device such as a flat panel detector (FPD) and images radiation transmitted through a weld point as image data, in place of imaging the transmitted radiation on the film as described above. However, systematization in undertaking and performing, by the judge, the judgment task related to the image data of the weld point has not been sufficiently considered, and a device contributing to improvement of the workability of the judge and reduction of the burden on the client of the judgment task has not been proposed.

The present invention has been made in view of the above-mentioned problems, and it is an object of the present invention to provide a non-destructive inspection judgment data management device and a non-destructive inspection judgment data management method with which the workability of a judge can be improved and a burden on a client of a judgment task can be reduced.

### Solution to Problem

In order to achieve the above-mentioned object, according to one aspect of the present invention, there is provided a non-destructive inspection judgment data management device including: a first database registration module configured to register image data related to a non-destructive inspection of a weld point in a first database; a second database registration module configured to register judge information on a judge undertaking a judgment task of judging whether a weld defect is present at the weld point based on the image data, in a second database; and an access control module configured to allow, based on contract information indicating that a contract for the judgment task has been established with the judge selected as a contractor of the judgment task among the judges registered in the second database, the contractor to access the image data related to the judgment task in the image data registered in the first database via Internet.

### Advantageous Effects of Invention

According to the non-destructive inspection judgment data management device of the one aspect of the present invention, the access control module allows the contractor of the judgment task to access the image data related to the judgment task in the image data related to the non-destructive inspection registered in the first database via the Internet based on the contract information indicating that the contract for the judgment task has been established with the judge selected as the contractor of the judgment task among the judges registered in the second database. Accordingly, the contractor (the judge) can access the image data related to the judgment task via the Internet and therefore can carryout the judgment task at a remote location without going to a welding site. In addition, the client of the judgment task can more easily secure the judge and can reduce the cost of stationing the judge. Accordingly, it is possible to improve the workability of the judge and reduce a burden on the client of the judgment task.

Problems, configurations, and effects other than those described above become apparent in the “Description of Embodiments” section described later.

### BRIEF DESCRIPTION OF DRAWINGS

FIG. 1 is an overall view of an example of a non-destructive inspection judgment task management system (1).

FIG. 2 is a data structure diagram of an example of a first database (31).

FIG. 3 is a data structure diagram of an example of a second database (32).

FIG. 4 is a data structure diagram of an example of a third database (33).

FIG. 5 is a block diagram of an example of a non-destructive inspection judgment data management device (2).

FIG. 6 is a hardware configuration diagram of an example of a computer (900) configuring each device of the non-destructive inspection judgment task management system (1).

FIG. 7 is a flowchart of an example of contract support processing related to a request and a contract for a judgment task.

FIG. 8 is a flowchart of the example of the contract support processing related to the request and the contract for the judgment task (continuation of FIG. 7).

FIG. 9 is a diagram of an example of a judgment task request screen (43).

FIG. 10 is a diagram of an example of a judge candidate screen (44A).

FIG. 11 is a diagram of an example of a judgment task contract request screen (52).

FIG. 12 is a flowchart of an example of judgment task support processing related to execution of a judgment task.

FIG. 13 is a flowchart of the example of the judgment task support processing related to the execution of the judgment task (continuation of FIG. 12).

FIG. 14 is a diagram of an example of a judgment task start screen (53).

FIG. 15 is a diagram of an example of a judgment result input screen (54A).

FIG. 16 is a diagram of an example of a judgment result confirmation screen (45).

FIG. 17 is a flowchart of an example of defect judgment analysis processing.

FIG. 18 is a schematic diagram of an example of machine learning processing and defect inference processing.

FIG. 19 is a flowchart of an example of the defect inference processing.

FIG. 20 is a diagram of an example of a judgment result input screen (54B) including defect inference data by the defect inference processing.

FIG. 21 is a flowchart of an example of judgment match analysis processing.

FIG. 22 is a diagram of an example of an analysis condition input screen (46).

FIG. 23 is a diagram of an example of a judge candidate screen (44B) including an analysis result of a judgment match tendency by the judgment match analysis processing.

### DESCRIPTION OF EMBODIMENTS

Embodiments for carrying out the present invention are described below with reference to the drawings. In the following description, a range required for the description for achieving the object of the present invention is schematically shown, and a range required for the description of a portion corresponding to the present invention is mainly described. A portion of which the description is omitted is based on a known technology.

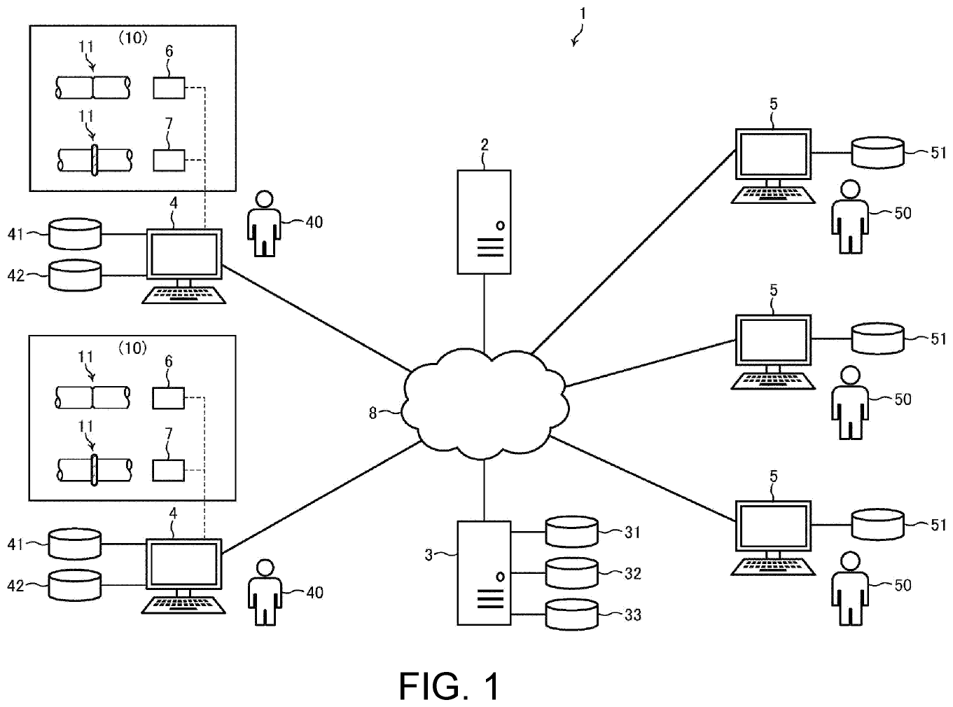

FIG. 1 is an overall view of an example of a non-destructive inspection judgment task management system 1. The non-destructive inspection judgment task management system 1 is a system for achieving business matching between a client 40 who requests a judgment task of judging whether there is a weld defect based on image data related to a non-destructive inspection of each of weld points 11 provided at various locations in a welding site 10 and a judge 50 (a contractor) who undertakes the judgment task, and for pooling various types of data (image data, defect judgment data, and the like) related to the judgment task.

The non-destructive inspection judgment task management system 1 includes a non-destructive inspection judgment data management device 2, a database device 3, a client's terminal 4, and a judge's terminal 5 as main components. The devices configuring the non-destructive inspection judgment task management system 1 are connected to a wired or wireless communication network 8 and configured to be able to transmit and receive various types of data mutually. In particular, the non-destructive inspection judgment data management device 2, the client's terminal 4 and the judge's terminal 5 are connected to one another via the Internet as a part of the communication network 8. The number and arrangement of each of the devices configuring the non-destructive inspection judgment task management system 1 and the connecting method of the devices are not limited to those of the example of FIG. 1.

The welding site 10 is, for example, a site at which a plant facility such as a natural gas plant, a petroleum processing plant, a chemical processing plant, a power plant, and a steel plant, a ship such as a tanker, a cargo ship, and a passenger ship, or infrastructure equipment such as railroad rails is constructed (built). In the welding site 10, workers including a welder, an imaging worker, and the like who belong to a plurality of sub-contractors undertaking a welding process and a non-destructive inspection process perform various works associated with the welding process and the non-destructive inspection process under process management by a site manager of a prime contractor. The welding site 10 is provided not only when the above-mentioned building is newly constructed but also when the building is renovated. The welding site 10 is not limited to the above-mentioned examples of building, and may be any building as long as the weld points 11 are provided at various locations therein.

The weld point 11 is represented in, for example, a spool diagram drawn as a part of design drawings of a plant, a ship, or the like that is the welding site 10. The weld point 11 is a point in the welding site 10, at which pipings allowing any fluid to flow therein are welded to each other, a piping and a piping joint member (for example, a flange, an elbow, or a tee) are welded to each other, or piping joint members are welded to each other. The weld point 11 is not limited to the above-mentioned examples, as long as the weld point 11 is a point at which members are welded to each other.

The welding process is a work process performed by the welder using a welding machine 6 under a welding condition determined for each weld point 11. In this embodiment, the welding process is described focusing on the case of using arc welding. However, any welding method, for example, gas welding, laser welding, electron beam welding, and resistance pressure welding may be used.

As the welding condition in the welding process, for example, diameter, thickness, material (base material), joint shape, welding material, preheating, post-weld heat treatment, shielding gas, electrical characteristics (welding current, welding voltage, and the like), and welding method (welding speed, welding direction, welding angle, and arc time) for the weld point 11 are determined. The welding condition is determined for each weld point 11 by, for example, operation instructions for the welding process, and information as a part of the welding condition is represented in a spool diagram. In addition, welding machine operation data in which the operating state of the welding machine 6 is recorded and preheating data in which the preheating state of the weld point 11 is recorded, for example, are acquired as a welding execution record in the welding process that has been performed under the welding condition.

The non-destructive inspection process includes an imaging process in which the imaging worker applies radiation (X-ray, y-ray, or the like) to the weld point 11 for which the welding process has been performed through use of an inspection machine 7 to acquire the intensity of radiation transmitted through the weld point 11 as image data, and an image judgment process in which the judge 50 judges whether there is a weld defect at that weld point 11 based on the image data of the weld point 11 related to the judgment task through use of the judge's terminal 5. Weld defects are classified into defect types such as a blowhole, a pit, a crack, an undercut, and an overlap. When the size, the depth, or the shape of a weld defect exceeds an allowable range, the weld point 11 is judged to be “defective” (fail), and when the size, the depth, or the shape of a weld defect does not exceed the allowable range, the weld point 11 is determined to be “non-defective” (pass). In the image judgment process, defect judgment data which indicates the result of the judgment of whether there is a weld defect based on the image data of the weld point 11 (defect judgment data) is acquired.

A judgment task is carried out after, for a request from the client 40 such as a sub-contractor or a prime contractor, the judge 50 undertaking the request is selected as a contractor 50a among a plurality of judges 50, and a contract for the judgment task is established between the client 40 and the contractor 50a. In the contract for the judgment task, for example, one or a plurality of weld points 11 for which judgment is to be performed in the judgment task (hereinafter referred to as “judged weld points 11a”) are identified, and a contract term including the amount of contract, the contract type (for example, a fixed salary, a commission, or a combination of a fixed salary and a commission), a judgment task deadline, and the like is determined.

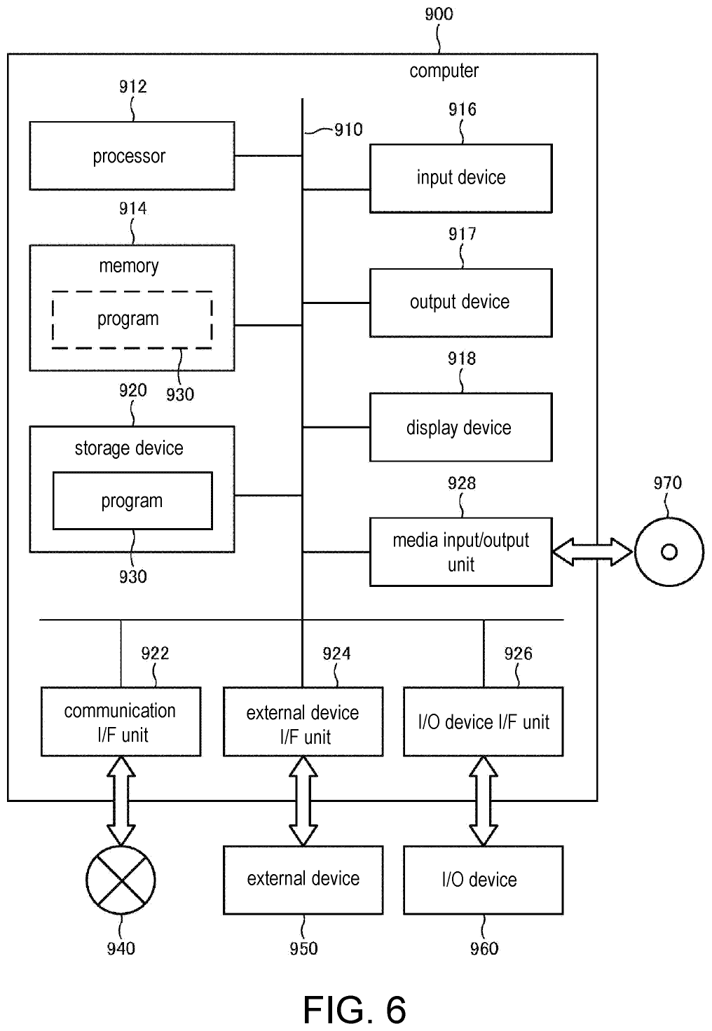

The non-destructive inspection judgment data management device 2 is configured by a general-purpose or dedicated computer (see FIG. 6 described later), for example. The non-destructive inspection judgment data management device 2 controls access to the database device 3 from another device and manages various types of data (image data, defect judgment data, and the like) related to a judgment task stored in the database device 3. Details of the non-destructive inspection judgment data management device 2 are described later.

The database device 3 is configured by a general-purpose or dedicated computer (see FIG. 6 described later), for example. The database device 3 includes the first to third databases 31 to 33 that store therein various types of data related to a judgment task. Details of the first to third databases 31 to 33 are described later.

The client's terminal 4 is configured by a general-purpose or dedicated computer (see FIG. 6 described later), for example, and is used by the client 40 of a judgment task. The client's terminal 4 receives various input operations via its input screen and displays various types of information via a display screen of an application, a browser, or the like. The client's terminal 4 transmits, when the client 40 requests a judgment task of the judge 50, image data of the weld point 11 related to that judgment task to the non-destructive inspection judgment data management device 2 via the Internet, and receives defect judgment data from the non-destructive inspection judgment data management device 2 as the result of execution of the judgment task.

The client's terminal 4 further includes a process execution record storage unit 41 for storing therein, for each weld point provided in the welding site 10 managed or undertaken by the client 40, a welding condition, a welding execution record acquired in a welding process, and an imaging execution record acquired in an imaging process and a contract information storage unit 42 for storing therein contract information indicating that a contract for a judgment task has been established with the judge 50. In the process execution record storage unit 41, welding execution date and time, welder ID, preheating data, welding machine operation data, and the like are registered as the welding execution record at any time by execution of the welding process at each weld point 11, and imaging date and time, imaging worker ID, imaging data, and the like are registered as the imaging execution record at any time by execution of the imaging process at each weld point 11. Therefore, the process execution record storage unit 41 has a record for each weld point 11 identified by a welding site ID, a drawing number, and a weld point number, and welding condition, welding execution record, and imaging execution record are registered in each record.

The judge's terminal 5 is configured by a general-purpose or dedicated computer (see FIG. 6 described later), for example, and is used by the judge 50 who carries out a judgment task at a location different from the welding site 10. The judge's terminal 5 receives various input operations via its input screen and displays various types of information via a display screen of an application, a browser, or the like, as with the client's terminal 4. The judge's terminal 5 receives image data of the weld point 11 related to the judgment task from the non-destructive inspection judgment data management device 2 via the Internet, displays the image data on its display screen, and transmits defect judgment data indicating a result of defect judgment by the judge 50 to the non-destructive inspection judgment data management device 2.

The judge's terminal 5 includes a contract information storage unit 51 that stores therein contract information indicating that a contract for the judgment task has been established with the client 40.

(Configuration of First to Third Databases 31 to 33)

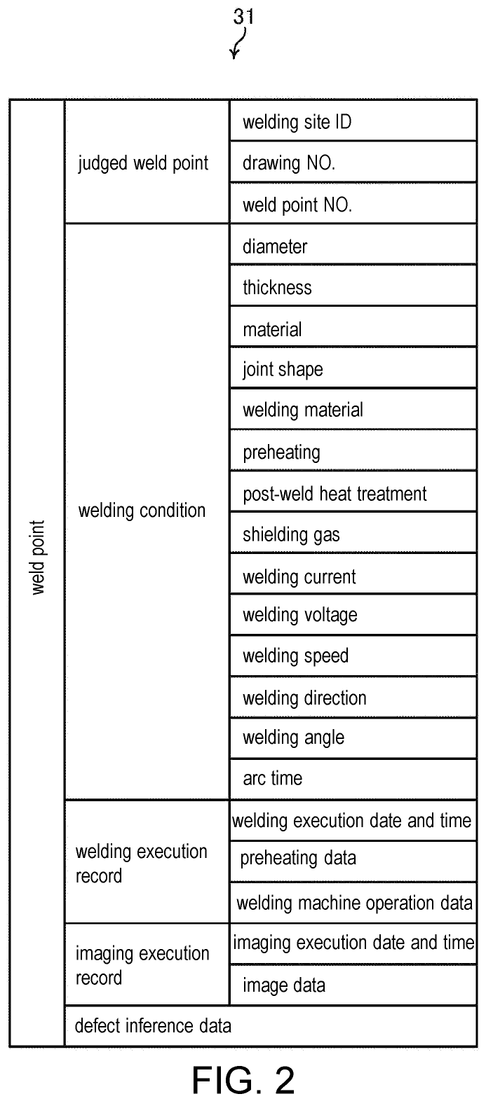

FIG. 2 is a data structure diagram of an example of the first database 31. The first database 31 has a record for each judged weld point 11a identified by a welding site ID, a drawing number, and a weld point number, and welding condition, welding execution record, imaging execution record, and defect inference data are registered in each record.

The welding condition includes, as its fields, diameter, thickness, material (base material), joint shape, welding material, preheating, post-weld heat treatment, shielding gas, welding current, welding voltage, welding speed, welding direction, welding angle, and arc time. The welding execution record includes welding execution date and time, preheating data, and welding machine operation data as its fields. The imaging execution record includes imaging execution date and time and image data as its fields. The image data includes one or a plurality of images for one weld point 11.

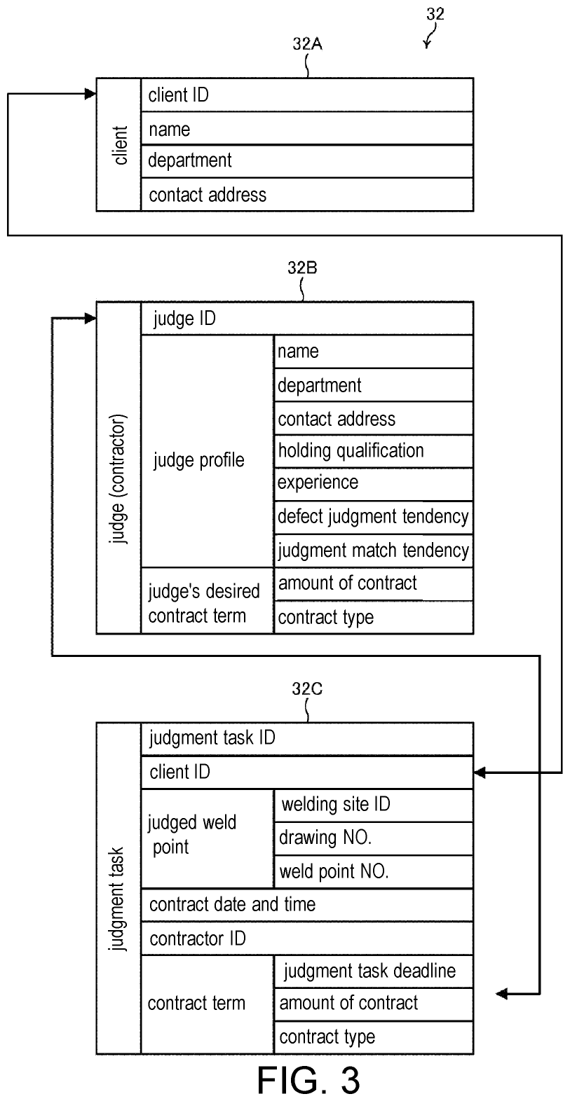

FIG. 3 is a data structure diagram of an example of the second database 32. The second database 32 is configured by a client table 32A in which client information on the client 40 is registered, a judge table 32B in which judge information on the judge 50 is registered, and a judgment task table 32C.

The client table 32A has a record for each client 40 identified by a client ID, and name, department, and contact address are registered in each record.

The judge table 32B has a record for each judge 50 identified by a judge ID, and judge profile and judge's desired contract term are registered in each record. The judge profile has name, department, contact address, holding qualification, experience, defect judgment tendency, and judgment match tendency as its fields. The judge's desired contract term includes the amount of contract and the contract type as its fields.

The judgment task table 32C has a record for each judgment task identified by a judgment task ID, and client ID, judged weld point 11a, contract date and time, contractor ID, and contract term are registered in each record. The judged weld point 11a has welding site ID, drawing number, and weld point number as its fields for identifying one or a plurality of weld points 11 for which judgment is to be performed in the judgment task. In the case of performing the judgment task for a plurality of weld points 11, the plurality of weld points 11 are identified in the field of judged weld point 11a. The contractor ID is identification information for identifying the judge 50 selected as the contractor 50a of the judgment task by a judge ID. The contract term includes judgment task deadline, the amount of contract, and the contract type as its fields.

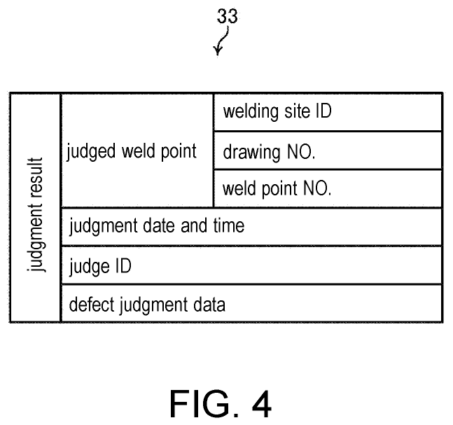

FIG. 4 is a data structure diagram of an example of the third database 33. The third database 33 has a record for each judged weld point 11a identified by a welding site ID, a drawing number, and a weld point number, and judgment date and time, judge ID, and defect judgment data are registered in each record.

The defect judgment data includes the presence or absence of a weld defect (“defective” or “non-defective”) and further includes a defect detail status indicating a detailed status of the defect in the case of “defective.” The defect detail status includes, as its fields, defect location indicating the location on the image data, defect type, size, and depth, for example. In the case in which a plurality of defects are captured in one image data, the defect judgment data includes the defect detail status for each defect.

The data structures of the first to third databases 31 to 33 are not limited to the above-mentioned example, and may be changed as appropriate. For example, a part of the above-mentioned fields may be omitted or a field other than the above-mentioned fields may be added. The first to third databases 31 to 33 may be configured in such a manner that the first and third databases 31 and 33 are integrated with each other, or may be configured to be divided into four or more databases, for example. Further, the first to third databases 31 to 33 may be prepared for each client 30 or for each welding site.

(Configuration of Non-Destructive Inspection Judgment Data Management Device 2)

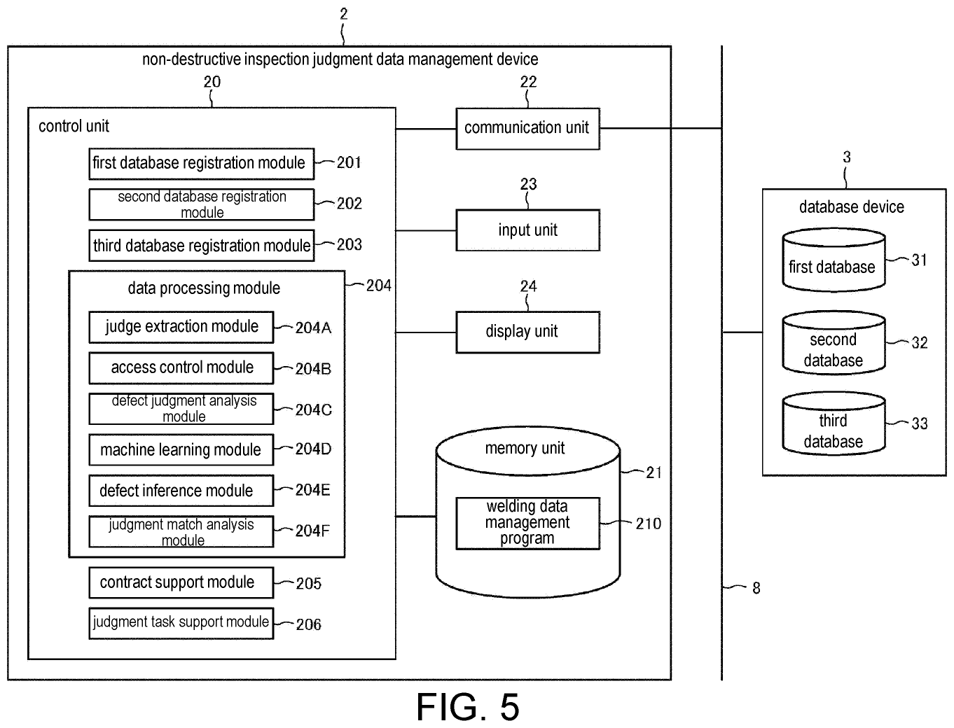

FIG. 5 is a block diagram of an example of the non-destructive inspection judgment data management device 2. The non-destructive inspection judgment data management device 2 includes a control unit 20 configured by a processor or the like, a memory unit 21 configured by a hard disk drive (HDD), a solid state drive (SSD), a memory, or the like, a communication unit 22 that is an interface for communication to and from the communication network 8, an input unit 23 configured by a keyboard and/or a mouse, for example, and a display unit 24 configured by a display or the like. The input unit 23 and the display unit 24 may be omitted.

The memory unit 21 stores therein a non-destructive inspection judgment data management program 210. Apart or the whole of the first to third databases 31 to 33 may be stored in the memory unit 21.

The control unit 20 executes the non-destructive inspection judgment data management program. 210 stored in the memory unit 21, to thereby function as a first database registration module 201, a second database registration module 202, a third database registration module 203, a data processing module 204, a contract support module 205, and a judgment task support module 206, as illustrated in FIG. 5. Details of each module of the control unit 20 are described later.

The first database registration module 201 registers welding condition, welding execution record in a welding process, and imaging execution record in an imaging process in the first database 31 to be associated with one another for each judged weld point 11a. It suffices that the first database registration module 201 registers at least image data.

The second database registration module 202 registers, for each client 40, name, department, and contact address in the second database 32 (the client table 32A) to be associated with one another as client information. The second database registration module 202 registers, for each judge 50, judge profile and judge's desired contract term in the second database 32 (the judge table 32B) to be associated with each other as judge information. It suffices that the second database registration module 202 registers the judge profile including at least a holding qualification as the judge information. The second database registration module 202 registers, for each judgment task, client ID, judged weld point 11a, contract date and time, contractor ID, and contract term in the second database 32 (the judgment task table 32C) to be associated with one another. In the case in which the judgment task is to be performed for a plurality of weld points 11, the second database registration module 202 registers a plurality of sets of welding site ID, drawing number, and weld point number with regard to the judged weld point 11a.

The third database registration module 203 registers, for each judged weld point 11a, judgment execution date and time, judge ID, and defect judgment data in the third database 33 as a judgment execution record in a judgment process. It suffices that the third database registration module 203 registers at least the defect judgment data.

The data processing module 204 performs predetermined processing based on information registered in the first to third databases 31 to 33. The data processing module 204 includes, as components performing the predetermined processing, a judge extraction module 204A, an access control module 204B, a defect judgment analysis module 204C, a machine learning module 204D, a defect inference module 204E, and a judgment match analysis module 204F. Details of the modules 204A to 204F of the data processing module 204 are described later.

The contract support module 205 cooperates with the data processing module 204 to perform various types of processing for supporting a request and a contract for a judgment task, for example, via a website for contracting judgment tasks. The judgment task support module 206 cooperates with the data processing module 204 to perform various types of processing for supporting execution of a judgment task, for example, via a website for executing judgment tasks. When performing the processing, the contract support module 205 and the judgment task support module 206 allow the client 40 already registered in the client table 32A and the judge 50 already registered in the judge table 32B to log in to the above-mentioned website, to thereby transmit and receive various types of information to and from the client's terminal 4 and the judge's terminal 5 via the Internet.

The functions of the respective modules included in the control unit 20 may be distributed into a plurality of devices and implemented by those devices, instead of being implemented by a single device (the non-destructive inspection judgment data management device 2 in this embodiment).

FIG. 6 is a hardware configuration diagram of an example of a computer 900 configuring each device of the non-destructive inspection judgment task management system 1.

Each of the non-destructive inspection judgment data management device 2, the database device 3, the client's terminal 4, and the judge's terminal 5 is configured by a general-purpose or dedicated computer 900. The computer 900 includes, as its main components, a bus 910, a processor 912, a memory 914, an input device 916, an output device 917, a display device 918, a storage device 920, a communication interface (I/F) unit 922, an external device I/F unit 924, an input/output (I/O) device I/F unit 926, and a media input/output unit 928, as illustrated in FIG. 6. The above-mentioned components may be omitted as appropriate depending on the application in which the computer 900 is used.

The processor 912 is configured by one or a plurality of arithmetic processing devices (central processing unit (CPU), micro-processing unit (MPU), digital signal processor (DSP), graphics processing unit (GPU), and the like) and operates as a control unit that controls the overall computer 900. The memory 914 stores therein various types of data and a program 930, and is configured by, for example, a volatile memory (such as a DRAM and an SRAM) serving as a main memory, a non-volatile memory (a ROM), a flash memory, and the like.

The input device 916 is configured by, for example, a keyboard, a mouse, a numeric keypad, and/or an electronic pen and serves as an input unit. The output device 917 is configured by, for example, a sound (audio) output device or a vibration device and serves as an output unit. The display device 918 is configured by, for example, a liquid crystal display, an organic EL display, an electronic paper display, or a projector and serves as an output unit. The input device 916 and the display device 918 may be configured integrally, like a touch panel display. The storage device 920 is configured by, for example, an HDD and/or an SSD and serves as a memory unit. The storage device 920 stores therein various types of data required for execution of an operating system and the program 930.

The communication I/F unit 922 is connected to a network 940, such as the Internet and an intranet, (which may be the same as the communication network 8 of FIG. 1) in a wired or wireless manner and serves as a communication unit that transmits and receives data to and from another computer in accordance with a predetermined communication standard. The external device I/F unit 924 is connected to an external device 950, such as a camera, a printer, a scanner, and a reader/writer, in a wired or wireless manner and serves as a communication unit that transmits and receives data to and from the external device 950 in accordance with a predetermined communication standard. The I/O device I/F unit 926 is connected to an I/O device 960, such as various sensors and an actuator, and serves as a communication unit that transmits and receives various signals, such as a detection signal of a sensor and a control signal to an actuator, and data to and from the I/O device 960. The media input/output unit 928 is configured by a drive device, such as a digital versatile disc (DVD) drive and a compact disc (CD) drive, and writes and reads data to and from a medium (a non-transitory storage medium) 970, such as a DVD and a CD.

In the computer 900 having the above-mentioned configuration, the processor 912 calls the program 930 stored in the storage device 920, executes the program 930 in the memory 914, and controls each part of the computer 900 via the bus 910. The program 930 may be stored in the memory 914 in place of the storage device 920. The program 930 may be recorded in the medium 970 in an installable file format or an executable file format and be provided to the computer 900 via the media input/output unit 928. The program 930 may be provided to the computer 900 by being downloaded through the network 940 via the communication I/F unit 922. Moreover, the computer 900 may be configured in such a manner that various functions implemented by execution of the program 930 by the processor 912 are implemented by hardware, such as a field-programmable gate array (FPGA) and an application specific integrated circuit (ASIC).

The computer 900 is configured by, for example, a stationary computer or a portable computer, and is an electronic device of any form. The computer 900 may be a client computer, a server computer, or a cloud computer.

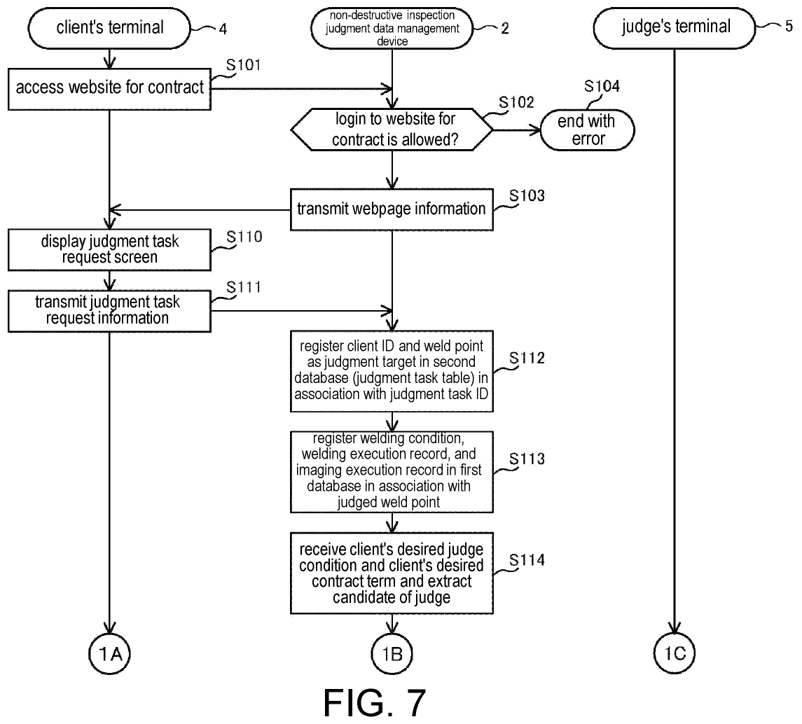

Each module of the non-destructive inspection judgment data management device 2 (each step of a non-destructive inspection judgment data management method executed by the non-destructive inspection judgment data management program 210) and a series of operations by the non-destructive inspection judgment task management system 1 are described below with reference to FIG. 7 to FIG. 23. The description is made assuming that in the second database 32, client information on a plurality of clients 40 has been registered in the second database 32 (in respective records of the client table 32A) by the second database registration module 202, and judge information on a plurality of judges 50 has been registered in the second database 32 (in respective records of the judge table 32B) by the second database registration module 202. The information already registered in the second database 32 (the client table 32A and the judge table 32B) may be edited (added, changed, or deleted) as appropriate.

(1) Request and Contract for Judgment Task

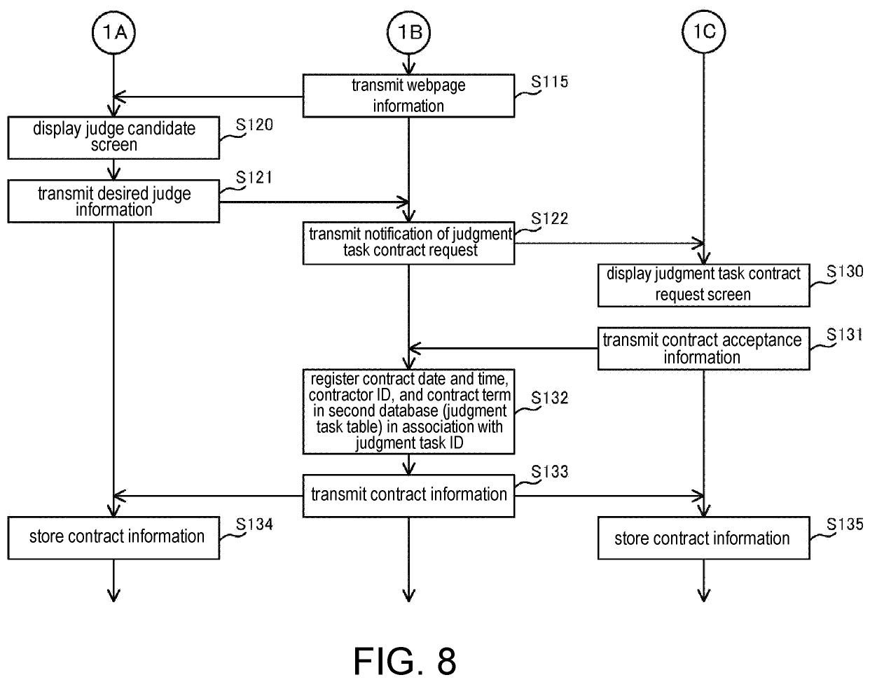

FIG. 7 and FIG. 8 are flowcharts of an example of contract support processing related to a request and a contract for a judgment task. FIG. 7 and FIG. 8 show an operation performed when the contract support module 205 cooperates with the judge extraction module 204A to support a procedure of requesting a judgment task of the judge 50 by the client 40 and establishing a contract for the judgment task between the client 40 and the judge 50.

First, in Step S101, when the client 40 accesses a website for contracting judgment tasks by using the client's terminal 4, the client's terminal 4 transmits a client ID for identifying the client 40 to the non-destructive inspection judgment data management device 2.

Then, in Step S102, when the non-destructive inspection judgment data management device 2 receives the client ID, the contract support module 205 determines whether to allow login to the website for contract in accordance with whether the client ID has been already registered in the client table 32A. When the contract support module 205 consequently determines that login is allowed (Step S102: Yes), information on a webpage for inputting a request for a judgment task is transmitted to the client's terminal 4 in Step S103, and the process proceeds to Step S110. Meanwhile, when the contract support module 205 determines that login is not allowed (Step S102: No), this determination result is transmitted to the client's terminal 4, and the process ends with an error in Step S104.

Next, in Step S110, when receiving the webpage information from the non-destructive inspection judgment data management device 2, the client's terminal 4 displays a judgment task request screen 43 based on the webpage information.

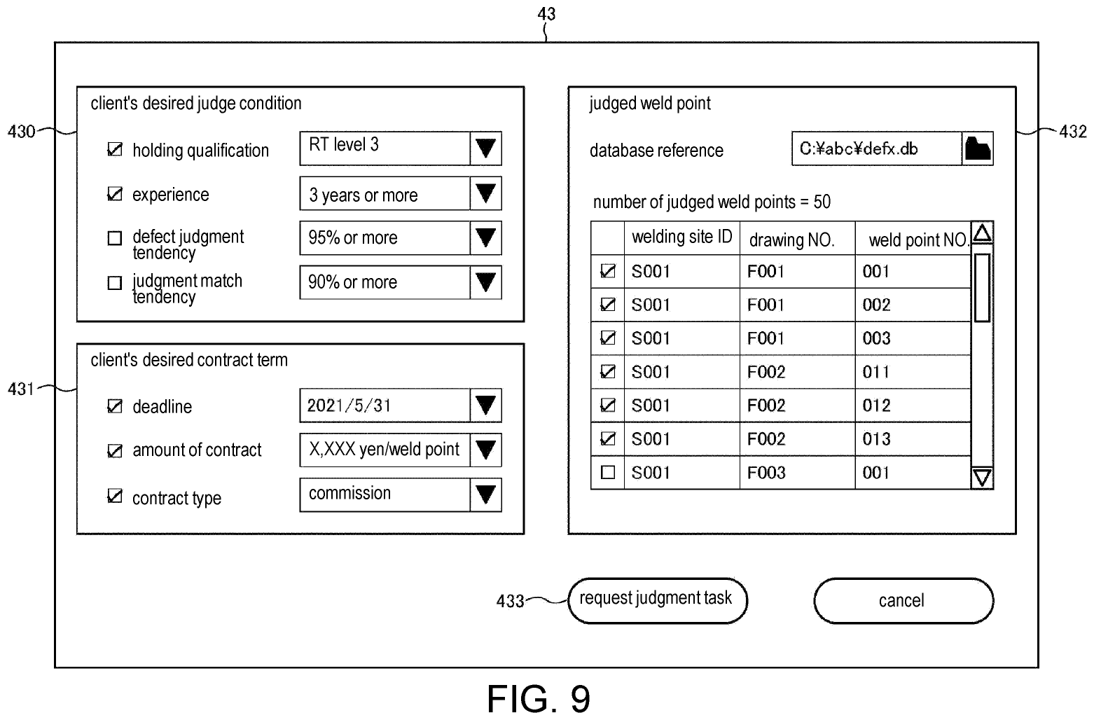

FIG. 9 is a diagram of an example of the judgment task request screen 43. The judgment task request screen 43 has an input field 430 to which the client 40 inputs a client's desired judge condition (for example, a holding qualification and an experience) as a judge profile desired by the client 40, an input field 431 to which the client 40 inputs a client's desired contract term (for example, a judgment task deadline, the amount of contract, and the contract type) as a contract term desired by the client 40, an input field 432 to which a judged weld point 11a is input, and a judgment task request button 433 for requesting a judgment task with the contents input to the input fields 430 to 432.

In the input field 432 for the judged weld point 11a, for example, a database reference to which the process execution record storage unit 41 refers, and a welding site ID, a drawing number, and a weld point number registered in the process execution record storage unit 41 are specified in a list format, and thus one or a plurality of weld points 11 for which judgment is to be performed is/are input.

Next, in Step S111, when the client 40 inputs the request contents of the judgment task to the input fields 430 to 432 and performs an input operation of pressing the judgment task request button 433 on the judgment task request screen 43, the client's terminal 4 transmits judgment task request information based on the input operation to the non-destructive inspection judgment data management device 2. At this time, the client's terminal 4 acquires information (a welding condition, a welding execution record, and an imaging execution record) in a record corresponding to the judged weld point 11a specified in the input field 432 from the process execution record storage unit 41. Thus, the judgment task request information includes the client ID, the client's desired judge condition, the client's desired contract term, and the judged weld point 11a, and also includes the welding condition, the welding execution record, and the imaging execution record (including image data) at the judged weld point 11a.

Next, in Step S112, when the non-destructive inspection judgment data management device 2 receives the judgment task request information from the client's terminal 4, the second database registration module 202 assigns anew judgment task ID to the judgment task request information and registers the client ID and the judged weld point 11a in the second database 32 (the judgment task table 32C) in association with the assigned judgment task ID. Then, in Step S113, the first database registration module 201 registers the welding condition, the welding execution record, and the imaging execution record (including image data) at the judged weld point 11a in the first database 31 in association with the judged weld point 11a included in the judgment task request information.

Next, in Step S114, the judge extraction module 204A receives the client ‘ s desired judge condition and the client’ s desired contract term included in the judgment task request information and extracts a candidate of judge 50 who matches the client's desired judge condition and the client's desired contract term among the judges 50 registered in the judge table 32B. For example, when the holding qualification “RT level 3” and the experience “3 years or more” are specified as the client's desired judge condition as illustrated in FIG. 9, the judge extraction module 204A refers to the holding qualification and the experience in the judge profile of each judge 50 registered in the judge table 32B and extracts the judge 50 satisfying the above-mentioned condition. Further, when the amount of contract “X,XX yen/weld point” and the contract type “commission” are specified as the client's desired contract term as illustrated in FIG. 9, the judge extraction module 204A refers to the amount of contract and the contract type in the judge's desired contract term of each judge 50 registered in the judge table 32B and extracts the judge 50 satisfying the above-mentioned term.

Next, in Step S115, the contract support module 205 transmits webpage information for displaying the candidate of judge 50 extracted by the judge extraction module 204A to the client's terminal 4. Then, in Step S120, when receiving the webpage information from the non-destructive inspection judgment data management device 2, the client's terminal 4 displays a judge candidate screen 44A based on the webpage information.

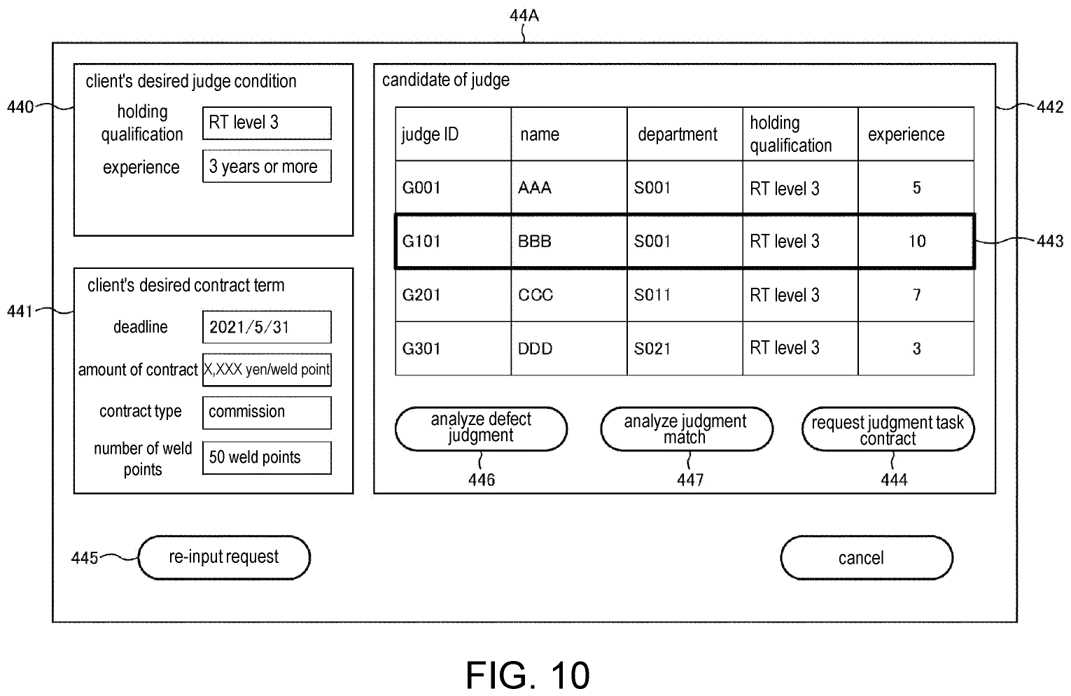

FIG. 10 is a diagram of an example of the judge candidate screen 44A. The judge candidate screen 44A has display fields 440 and 441 that display the client's desired judge condition and the client's desired contract term specified by the client 40, a display field 442 that displays the candidate of judge 50 extracted by the judge extraction module 204A, a selection frame 443 for selecting the judge 50 desired as the contractor 50a by the client 40 among the candidates of judge 50 displayed in the display field 442, a judgment task contract request button 444 for requesting a contract for a judgment task of the judge 50 selected by the selection frame 443, a request re-input button 445 for re-inputting the request contents of the judgment task, a defect judgment analyze button 446 for analyzing a defect judgment tendency as a feature of the judge 50, and a judgment match analyze button 447 for analyzing a judgment match tendency as a feature of the judge 50. The judge candidate screen 44A illustrated in FIG. 10 displays four judges 50 extracted as candidates of judge 50 by the judge extraction module 204A in a list format. Details of operations performed when the defect judgment analyze button 446 is pressed and when the judgment match analyze button 447 is pressed are described later.

Next, in Step S121, when the client 40 selects one of the candidates of judge 50 by the selection frame 443 and performs an input operation of pressing the judgment task contract request button 444 on the judge candidate screen 44A, the client's terminal 4 transmits desired judge information based on the input operation to the non-destructive inspection judgment data management device 2. The desired judge information includes, for example, the judge ID indicating the candidate of judge 50 selected by the client 40.

Next, in Step S122, when the non-destructive inspection judgment data management device 2 receives the desired judge information from the client's terminal 4, the contract support module 205 transmits a notification of judgment task contract request to the judge's terminal 5 of the judge 50 identified by the judge ID included in the desired judge information. The notification of judgment task contract request is transmitted to, for example, the contact address of the judge 50 as an email or a groupware message. The notification of judgment task contract request includes, for example, the name and department of the client 40, the client's desired contract term, and the number of judged weld points 11a based on the judgment task request information received in Step S112.

Next, in Step S130, when receiving the notification of judgment task contract request from the non-destructive inspection judgment data management device 2, the judge's terminal 5 displays a judgment task contract request screen 52 based on information on a webpage that is accessible from the notification of judgment task contract request.

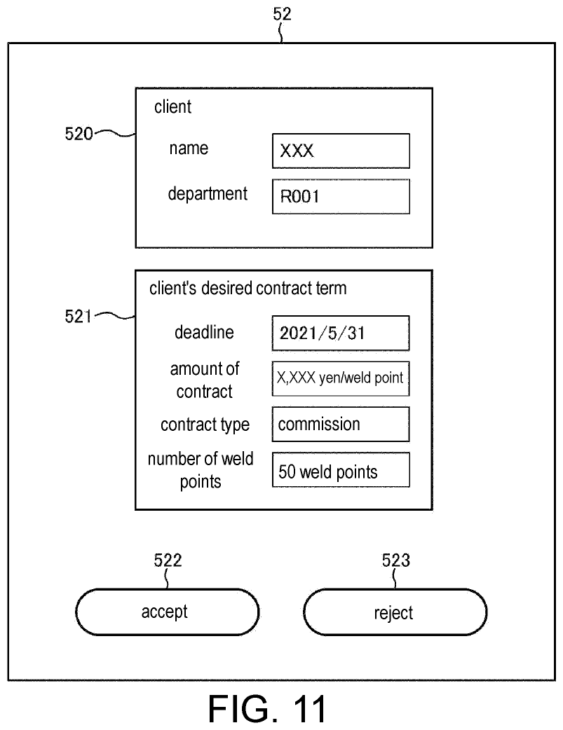

FIG. 11 is a diagram of an example of the judgment task contract request screen 52. The judgment task contract request screen 52 has a display field 520 that displays the name and department of the client 40, a display field 521 that displays the client's desired contract term, an accept button 522 for accepting the judgment task request, and a reject button 523 for rejecting the judgment task request.

Next, in Step S131, when the judge 50 performs an acceptance operation of pressing the accept button 522 on the judgment task contract request screen 52, the judge's terminal 5 transmits contract acceptance information based on the acceptance operation to the non-destructive inspection judgment data management device 2.

Next, in Step S132, when the non-destructive inspection judgment data management device 2 receives the contract acceptance information from the judge's terminal 5, the second database registration module 202 registers reception date and time of the contract acceptance information in the second database 32 (the judgment task table 32C) as contract date and time in association with the judgment task ID assigned in Step S112, and also registers the judge ID included in the judge selection information received in Step S121 in the second database 32 (the judgment task table 32C) as a contractor ID. Further, the second database registration module 202 registers the client's desired contract term included in the judgment task request information received in Step S112 in the second database 32 (the judgment task table 32C) as a contract term.

Next, in Step S133, the contract support module 205 transmits contract information indicating that a contract for the judgment task has been established to the client's terminal 4 and the judge's terminal 5. The contract information includes, for example, the judgment task ID, the client ID, the contract date and time, the contractor ID, and the contract term.

Then, in Step S134 and Step S135, when receiving the contract information from the non-destructive inspection judgment data management device 2, the client's terminal 4 and the judge's terminal 5 store the contract information in the contract information storage unit 42 of the client's terminal 4 and the contract information storage unit 51 of the judge's terminal 5, respectively, and the series of steps of processing is ended. When the reject button 523 is pressed on the judgment task contract request screen 52 illustrated in FIG. 11, this fact is notified to the client's terminal 4, and then the client 40 may select another judge 50 or re-input the request contents of the judgment task, for example.

As described above, the contract support module 205 cooperates with the judge extraction module 204A to support a procedure of requesting a judgment task of the judge 50 by the client 40 and establishing a contract for the judgment task between the client 40 and the judge 50. At this time, the judge extraction module 204A receives a client's desired judge condition and a judge's desired contract term desired by the client 40 of the judgment task via the judgment task request screen 43 illustrated in FIG. 9, for example, and extracts the judge 50 who matches the client's desired judge condition and the client's desired contract term among the judges 50 registered in the second database. The client 40 can thus request the judgment task of the judge 50 who matches the client's desire.

(2) Execution of Judgment Task

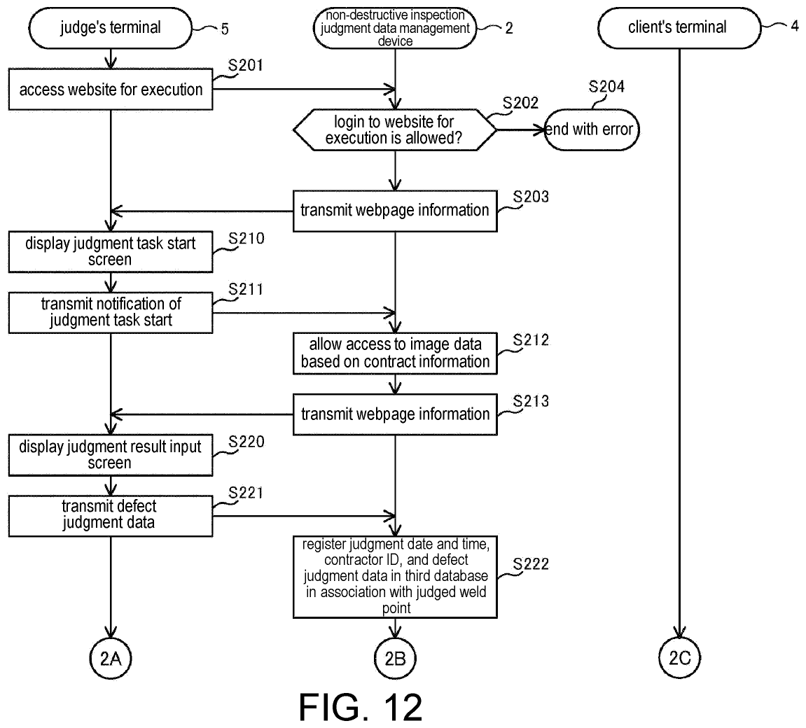

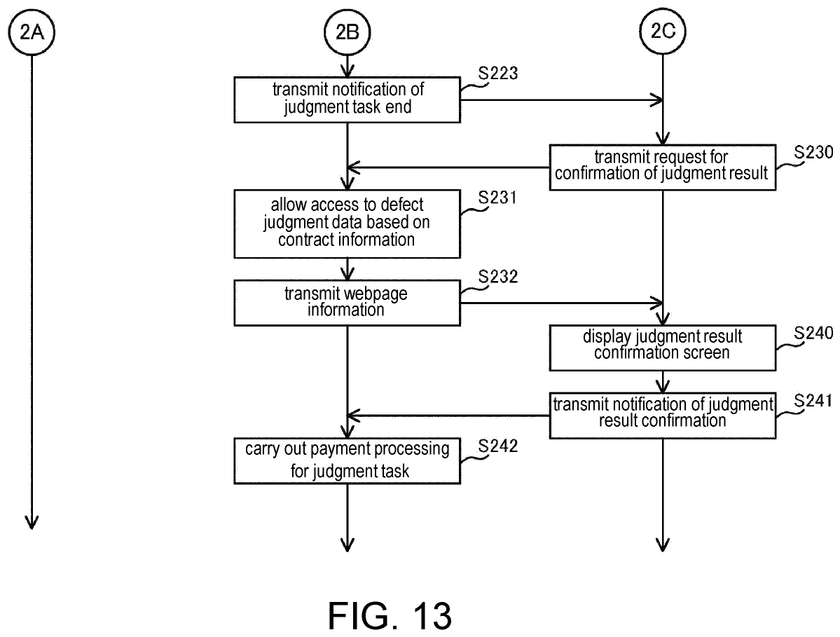

FIG. 12 and FIG. 13 are flowcharts of an example of judgment task support processing related to execution of a judgment task. FIG. 12 and FIG. 13 show an operation performed when the judgment task support module 206 cooperates with the access control module 204B to support execution of a judgment task by the contractor 50a and to provide the execution result of the judgment task to the client 40.

First, in Step S201, when the contractor 50a accesses a website for executing judgment tasks by using the judge's terminal 5, the judge's terminal 5 transmits a contractor ID (judge ID) for identifying the contractor 50a to the non-destructive inspection judgment data management device 2.

Then, in Step S202, when the non-destructive inspection judgment data management device 2 receives the contractor ID, the judgment task support module 206 determines whether to allow login to the website for execution in accordance with whether the contractor ID has been already registered in the judge table 32B. When the judgment task support module 206 consequently determines that login is allowed (Step S202: Yes), information on a webpage for instructing start of the judgment task undertaken by the contractor 50a to the judge's terminal 5 in Step S203, and the process proceeds to Step S210. Meanwhile, when the judgment task support module 206 determines that login is not allowed (Step S202: No), this determination result is transmitted to the judge's terminal 5, and the error processing is ended in Step S204.

In Step S210, when receiving the webpage information from the non-destructive inspection judgment data management device 2, the judge's terminal 5 displays a judgment task start screen 53 based on the webpage information.

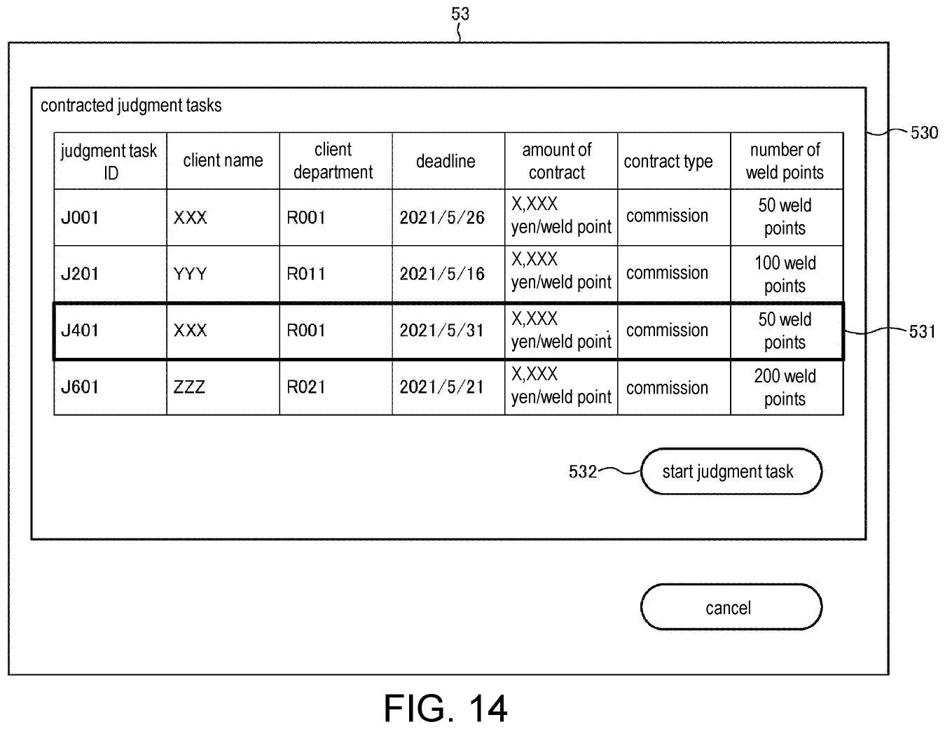

FIG. 14 is a diagram of an example of the judgment task start screen 53. The judgment task start screen 53 has a display field 530 that displays a judgment task for which the contractor 50a has made a contract, a selection frame 531 for selecting one of judgment tasks displayed in the display field 530 for which the contractor 50a instructs the start, and a judgment task start button 532 for instructing the start of the judgment task selected by the selection frame 531.

Next, in Step S211, when the contractor 50a selects the judgment task for which start is to be instructed by the selection frame 531 and performs an input operation of pressing the judgment task start button 532 on the judgment task start screen 53, the judge's terminal 5 reads out contract information related to the judgment task for which start has been instructed by the contractor 50a from the contract information storage unit 42, generates a notification of judgment task start including the read contract information, and transmits the notification to the non-destructive inspection judgment data management device 2.

Next, in Step S212, when the non-destructive inspection judgment data management device 2 receives the notification of judgment task start from the judge's terminal 5, the access control module 204B allows the contractor 50a to access image data of the judged weld point 11a related to the judgment task identified by the judgment task ID in the contract information in image data registered in the first database 31 via the Internet based on the contract information included in the notification of judgment task start. The image data of the judged weld point 11a related to the judgment task is identified by identifying one or a plurality of judged weld points 11a associated with the judgment task ID in the contract information in the second database 32 (the judgment task table 32C) and further identifying one or a plurality of pieces of image data associated with the identified judged weld point(s) 11a in the first database 31.

Next, in Step S213, the judgment task support module 206 transmits webpage information for displaying the image data for which access is allowed by the access control module 204B, to the judge's terminal 5. In the case in which a welding condition and a welding execution record are further registered in the first database 31 in association with the judged weld point 11a as illustrated in FIG. 5, the access control module 204B may allow the contractor 50a to access at least one of the welding condition or the welding execution record in addition to the image data via the Internet. In this case, the judgment task support module 206 may transmit webpage information for displaying the image data for which access is allowed by the access control module 204B and at least one of the welding condition or the welding execution record to the judge's terminal 5.

Next, in Step S220, when receiving the webpage information from the non-destructive inspection judgment data management device 2, the judge's terminal 5 displays a judgment result input screen 54A based on the webpage information.

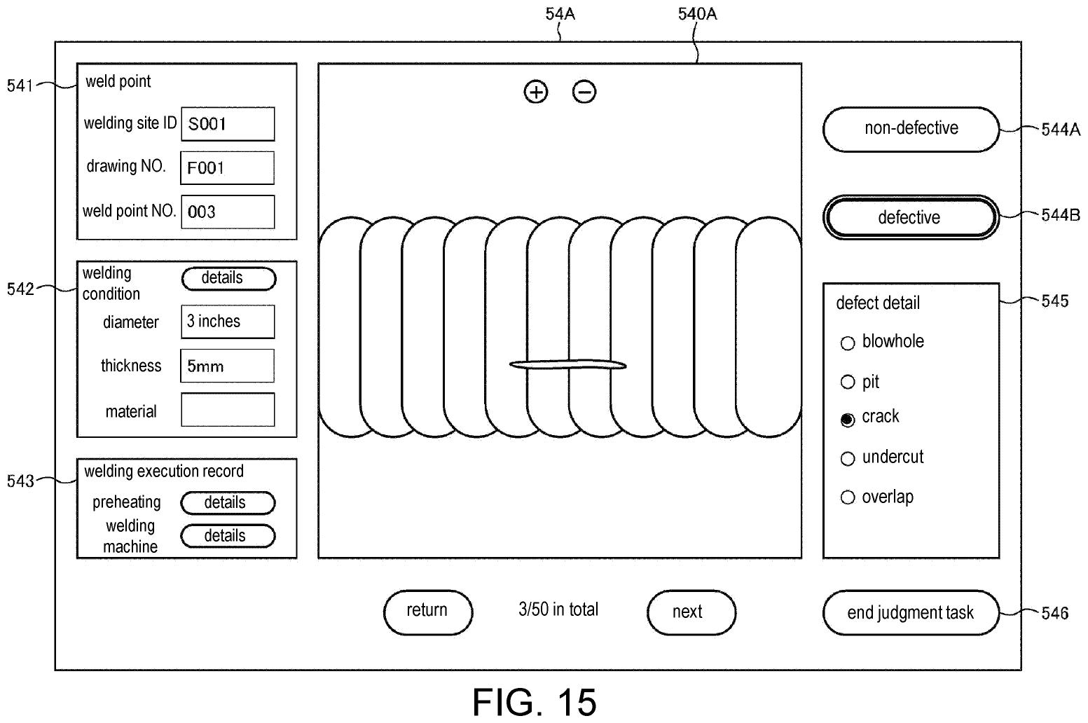

FIG. 15 is a diagram of an example of the judgment result input screen 54A. The judgment result input screen 54A has: an image display region 540A that displays image data related to a judgment task; a display field 541 that displays a welding site ID, a drawing number, and a weld point number that identify a judged weld point 11a; a display field 542 that displays a welding condition; a display field 543 that displays a welding execution record; a first defect judgment instruction button 544A for instructing, when the contractor 50a judges that the weld point is “non-defective,” the result of this judgment; a second defect judgment instruction button 544B for instructing, when the contractor 50a judges that the weld point is “defective,” the result of this judgment; an input field 545 for inputting a defect detail status when the contractor 50a judges that the weld point is “defective”; and a judgment task end button 546 for instructing end of the judgment task.

Next, in Step S221, on the judgment result input screen 54A, the contractor 50a visually checks the image data of each judged weld point 11a displayed in the image display region 540A, instructs a defect judgment result for the image data of each judged weld point 11a by using the first and second defect judgment instruction buttons 544A and 544B and the input field 545, and performs an input operation of pressing the judgment task end button 546. The judge's terminal 5 then transmits defect judgment data based on the input operation to the non-destructive inspection judgment data management device 2.

Next, in Step S222, when the non-destructive inspection judgment data management device 2 receives the defect judgment data from the judge's terminal 5, the third database registration module 203 registers the defect judgment data in the third database 33 in association with the judged weld point 11a. In this registration, the third database registration module 203 registers the date and time of reception of the defect judgment data as judgment date and time in the third database 33 and also registers the contractor ID (judge ID) received in Step S201 as a judge ID in the third database 33. In the case in which the judgment task is to be performed for a plurality of weld points 11, the third database registration module 203 registers, for each judged weld point 11a, the judgment date and time, the contractor ID (judge ID), and the defect judgment data in the third database 33.

The defect judgment data registered in the third database 33 may be checked by the client 40, as described later. In this case, at least one defect judgment result included in the defect judgment data is checked by another judge of the client 40. When a difference between the judgment results by both the judges is found by this check, the contractor 50a performs defect judgment again and re-inputs defect judgment data. Thus, final defect judgment data by the contractor 50a is registered in the third database 33. In addition, the defect judgment result by the other judge of the client 40 may also be registered in the third database 33 together with the final defect judgment result by the contractor 50a.

Next, in Step S223, when confirming the end of the judgment task, the judgment task support module 206 transmits a notification of judgment task end to the client's terminal 4 of the client 40 identified by the client ID in the contract information included in the notification of judgment task start received in Step S212. The notification of judgment task end is transmitted to, for example, the contact address of the client 40 as an email or a groupware message. The notification of judgment task end includes, for example, the contract information included in the notification of judgment task start received in Step S212.

Next, in Step S230, the client's terminal 4 receives the notification of judgment task end from the non-destructive inspection judgment data management device 2 and transmits a request for confirmation of judgment result to the non-destructive inspection judgment data management device 2 as a response to the notification of judgment task end. The request for confirmation of judgment result includes, for example, the contract information included in the notification of judgment task start or contract information stored in the contract information storage unit 42.

Then, in Step S231, when the non-destructive inspection judgment data management device 2 receives the request for confirmation of judgment result from the client's terminal 4, the access control module 204B allows the client 40 to access defect judgment data related to the judgment task identified by the judgment task ID in the contract information in defect judgment data registered in the third database 33 via the Internet based on the contract information included in the request for confirmation of judgment result.

Next, in Step S232, the judgment task support module 206 transmits webpage information for displaying the defect judgment data for which access is allowed by the access control module 204B, to the client's terminal 4. Then, in Step S240, when receiving the webpage information from the non-destructive inspection judgment data management device 2, the client's terminal 4 displays a judgment result confirmation screen 45 based on the webpage information.

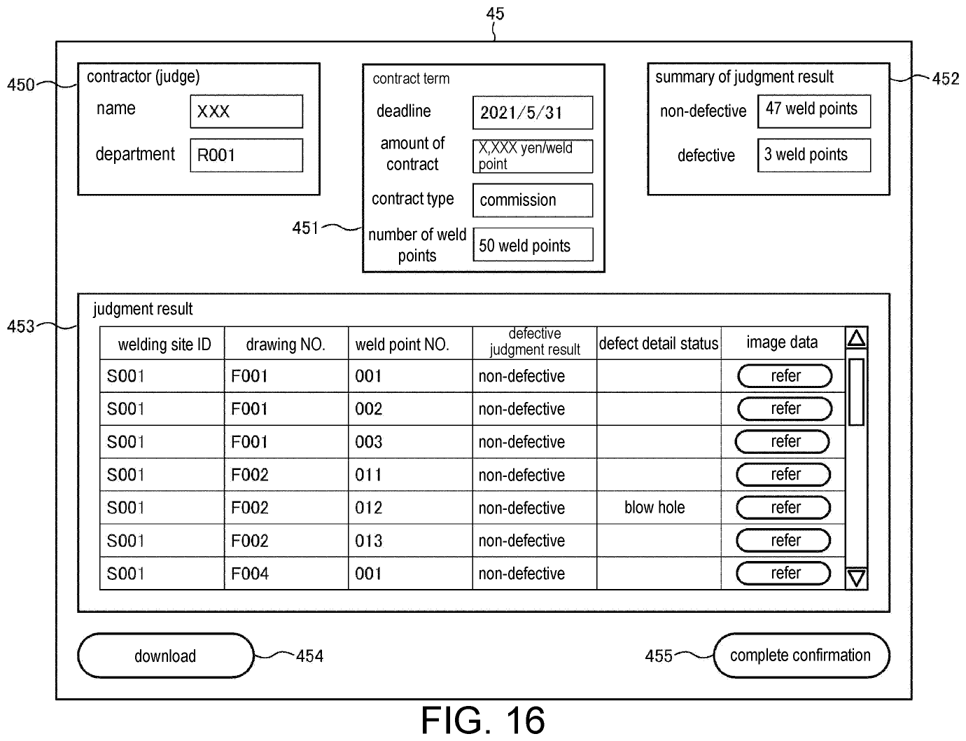

FIG. 16 is a diagram of an example of the judgment result confirmation screen 45. The judgment result confirmation screen 45 has a display field 450 that displays the name and department of the contractor 50a, a display field 451 that displays the contract term, a display field 452 that displays the summary of the defect judgment result, a display field 453 that displays details of the defect judgment result, a download button 454 for downloading defect judgment data indicating the defect judgment result to the client's terminal 4, and a confirmation complete button 455 for instructing that the client 40 has completed confirmation of the defect judgment result. The display field 450 related to the contractor 50a and the display field 451 related to the contract term may be omitted as appropriate depending on, for example, the attribute (the department or the like) of the client 40 who uses the client's terminal 4.

Next, in Step S241, when the client 40 confirms the defect judgment result of each judged weld point 11a displayed in the display field 453 and performs an input operation of pressing the confirmation complete button 455 on the judgment result confirmation screen 45, the client's terminal 4 transmits a notification of judgment result confirmation based on the input operation to the non-destructive inspection judgment data management device 2. Then, in Step S242, when the non-destructive inspection judgment data management device 2 receives the notification of judgment result confirmation from the client's terminal 4, the judgment task support module 206 carries out payment processing for the contractor 50a based on the contract term for the judgment task, and the series of steps of processing is ended.

As described above, the judgment task support module 206 cooperates with the access control module 204B to support execution of a judgment task by the contractor 50a and provide the result of execution of the judgment task to the client 40. At this time, the access control module 204B allows the contractor 50a of a judgment task to access image data related to the judgment task in the image data registered in the first database 31 via the Internet based on the contract information indicating that the contract for the judgment task has been established with the judge 50 selected as the contractor 50a of the judgment task among judges 50 registered in the second database 32. Accordingly, the contractor 50a can access the image data related to the judgment task via the Internet and therefore can carry out the judgment task at a remote location without going to the welding site 10. In addition, the client 40 of the judgment task can more easily secure the judge 50 and can reduce the cost of stationing the judge 50. Accordingly, it is possible to improve the workability of the judge 50 and reduce a burden on the client 40 of the judgment task.

(3) Analysis of Defect Judgment Tendency of Judge

The defect judgment analysis module 204C performs defect judgment analysis processing of analyzing a defect judgment tendency that shows a tendency at the time when the judge 50 has judged whether there is a weld defect at the judged weld point 11a with respect to the judge 50 as an analysis axis, based on a judge ID and defect judgment data registered in the third database 33. At this time, the defect judgment analysis module 204C receives a predetermined analysis condition and performs statistical processing in accordance with the analysis condition, to thereby analyze the defect judgment tendency. The defect judgment analysis module 204C may refer further to a welding condition and a welding execution record registered in the first database 31 and analyze the defect judgment tendency.

A statistical index value representing the defect judgment tendency may be a defective judgment ratio calculated by using the total number of the judged weld points 11a for which the judge 50 has performed an image judgment process as a denominator and the number of the judged weld points 11a that have been judged as being “defective” by the judge 50 as a numerator, or a non-defective judgment ratio calculated by using the number of the judged weld points 11a that have been judged as being “non-defective” by the judge 50 as a numerator, for example. Further, the defective judgment tendency may be a defective judgment ratio or a non-defective judgment ratio with regard to a specific one of the types of defects. As the analysis condition, an analysis target range and an analysis axis, for example, are specified in addition to the statistical index value described above.

The analysis target range specifies a range of records for which analysis is to be performed among records registered in the third database 33. The analysis target range is specified by, for example, time (for example, past one week, one month, or one year), and the defect judgment analysis module 204C extracts a record in which judgment date and time matching the specified time is registered as an analysis target. Further, the analysis target range is specified by, for example, the type of defect, and the defect judgment analysis module 204C extracts a record in which defect judgment data matching the specified type of defect is registered as an analysis target. The analysis target range may be specified by a welding condition and a welding execution record registered in the first database 31.

The analysis axis is specified by, for example, time (for example, on a daily basis, on a weekly basis, or on a monthly basis) in addition to the judge 50, and the defect judgment analysis module 204C analyzes the defect judgment tendency with respect to the specified time as the analysis axis. Further, the analysis axis is specified by, for example, the type of defect in addition to the judge 50, and the defect judgment analysis module 204C analyzes the defect judgment tendency with respect to the specified type of defect as the analysis axis. The analysis axis may be specified by a welding condition and a welding execution record registered in the first database 31, in addition to the judge 50.

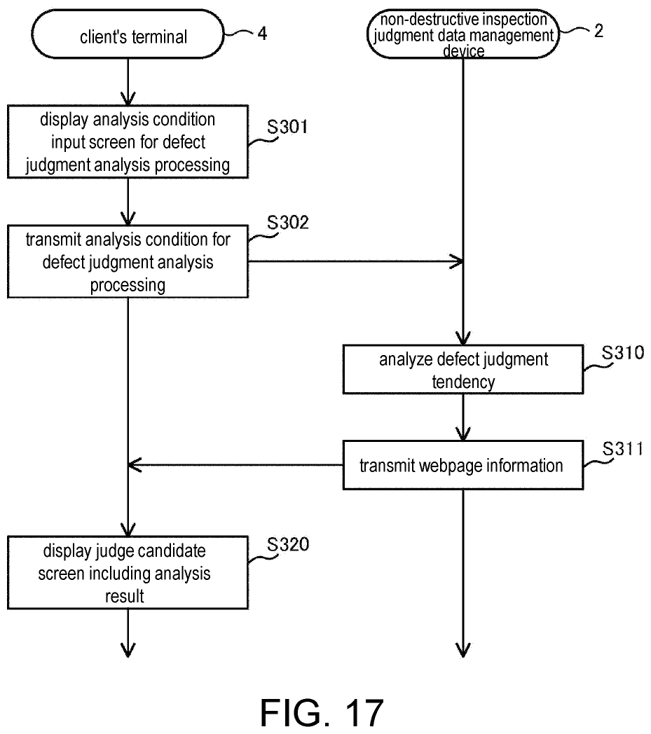

FIG. 17 is a flowchart of an example of defect judgment analysis processing. FIG. 17 shows an operation performed when the defect judgment analyze button 446 on the judge candidate screen 44A (see FIG. 10) displayed in Step S120 of FIG. 8 is pressed, and the defect judgment analysis module 204C receives an analysis condition in the defect judgment analysis processing from the client's terminal 4 and analyzes the defect judgment tendency under the analysis condition.

First, in Step S301, when the client 40 performs an input operation of pressing the defect judgment analyze button 446 on the judge candidate screen 44A (see FIG. 10), the client's terminal 4 displays an analysis condition input screen based on the input operation.

Next, in Step S302, when the client 40 specifies an analysis condition on the analysis condition input screen and performs an input operation of starting analysis, the client's terminal 4 transmits the analysis condition for the defect judgment analysis processing based on the input operation to the non-destructive inspection judgment data management device 2.

Next, in Step S310, when the non-destructive inspection judgment data management device 2 receives the analysis condition for the defect judgment analysis processing from the client's terminal 4, the defect judgment analysis module 204C analyzes the defect judgment tendency under the received analysis condition. Specifically, the defect judgment analysis module 204C extracts a record matching the analysis target range specified as the analysis condition from the third database 33. The defect judgment analysis module 204C then performs statistical processing for the extracted records in accordance with the statistical index value and the analysis axis specified as the analysis condition, to thereby derive the analysis result of the defect judgment tendency.

Next, in Step S311, the contract support module 205 transmits a webpage for displaying the analysis result of the defect judgment tendency to the client's terminal 4. Then, in Step S320, when receiving the webpage information from the non-destructive inspection judgment data management device 2 as a response to the analysis condition, the client's terminal 4 displays a judge candidate screen based on the webpage information.

As described above, the defect judgment analysis module 204C analyzes a defect judgment tendency based on information registered in the third database 33. When the analysis result of the defect judgment tendency is displayed on, for example, the judge candidate screen, the client 40 can use the analysis result as reference information for selecting the judge 50 to whom the client 40 requests a judgment task. As an example of analysis of the defect judgment tendency, it is considered that, in the case in which the defect judgment result by the contractor 50a and the defect judgment result by another judge of the client 40 have been registered in the third database 33, analysis is performed by using those defect judgment results. According to this example, it is possible to analyze a tendency of overlooking a defect for each contractor 50a.

(4) Inference of Weld Defect Using Learning Model

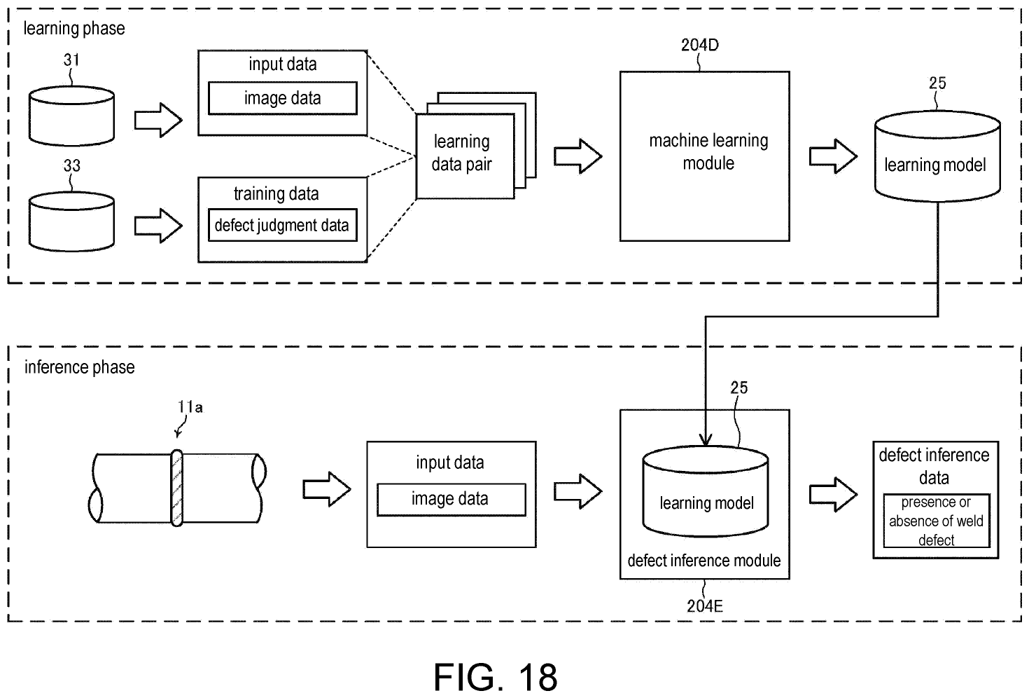

FIG. 18 is a schematic diagram of an example of machine learning processing and defect inference processing.

The machine learning module 204D performs machine learning processing that inputs a plurality of learning data pairs to a learning model 25 to cause the learning model 25 to learn a correlation between input data and training data by machine learning. Each learning data pair is configured by associating, for a common judged weld point 11a, image data registered in the first database 31 as the input data and defect judgment data registered in the third database 33 as the training data with each other.

The learning model 25 is configured by, for example, a convolutional neural network (including deep learning). A pixel value of each pixel included in image data is input to an input layer of the learning model 25, and an output layer of the learning model 25 outputs defect inference data with regard to the image data. For example, the learning model 25 may output an inference result (binary classification) obtained by judging whether there is a weld defect as the defect inference data or output an inference result (multi-value classification) obtained by judging the type of defect in addition to the presence or absence of a weld defect as the defect inference data. Further, in the case in which a plurality of defects are imaged in one image data, the learning model 25 may output an inference result obtained by judging the position and type of defect for each defect as the defect inference data.

The machine learning module 204D inputs input data configuring a learning data pair to the input layer of the learning model 25, and then adjusts weight parameters associated between the input and output layers such that an evaluation value of an error function that compares defect inference data output from the output layer of the learning model 25 and training data configuring the learning data pair with each other become smaller, by using the error function. The machine learning module 204D repeats the above-mentioned operation through use of a plurality of learning data pairs, and stores weight parameters at the time when a predetermined learning end condition is satisfied as the trained learning model 25 in the memory unit 21, for example.

The defect inference module 204E performs defect inference processing of inferring whether there is a weld defect at a weld point 11 as an inference target and outputting the defect inference data by inputting image data at the weld point 11 to the learning model 25 (with its weight parameters adjusted) as the input data. The weld point 11 as the inference target is the judged weld point 11a corresponding to a record in which the image data is recorded in the first database 31. Therefore, the defect inference processing is performed at any timing after an imaging process is performed.

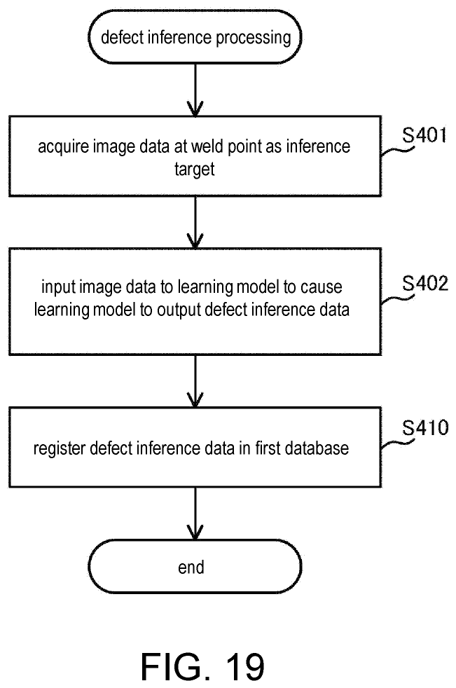

FIG. 19 is a flowchart of an example of the defect inference processing. FIG. 19 shows an operation performed when the defect inference module 204E performs the defect inference processing after Step S113 of FIG. 7.

First, in Step S401, the defect inference module 204E acquires image data in an imaging execution record at the judged weld point 11a included in the judgment task request information received in Step S112 of FIG. 7, as image data of the weld point 11 as an inference target.

Next, in Step S402, the defect inference module 204E inputs the image data at the weld point 11 as the inference target to the input layer of the learning model 25, and causes the output layer of the learning model 25 to output defect inference data. Then, in Step S410, the defect inference module 204E registers the defect inference data output from the learning model 25 in the first database 31, and the series of steps of processing is ended. In the case in which the judgment task request information includes a plurality of pieces of image data at a plurality of judged weld points 11a, the defect inference processing is performed for each piece of image data.

The defect inference data registered in the first database 31 in the above-mentioned manner is used as support information when the contractor 50a carries out a judgment task. Specifically, in Step S212 of FIG. 12, the access control module 204B allows the contractor 50a to access not only the image data but also the defect inference data via the Internet based on the contract information, and in Step S213, the judgment task support module 206 transmits webpage information for displaying the image data and the defect inference data for which access is allowed by the access control module 204B, to the judge's terminal 5. Thus, the judge's terminal 5 displays a judgment result input screen 54B based on the webpage information in Step S220.

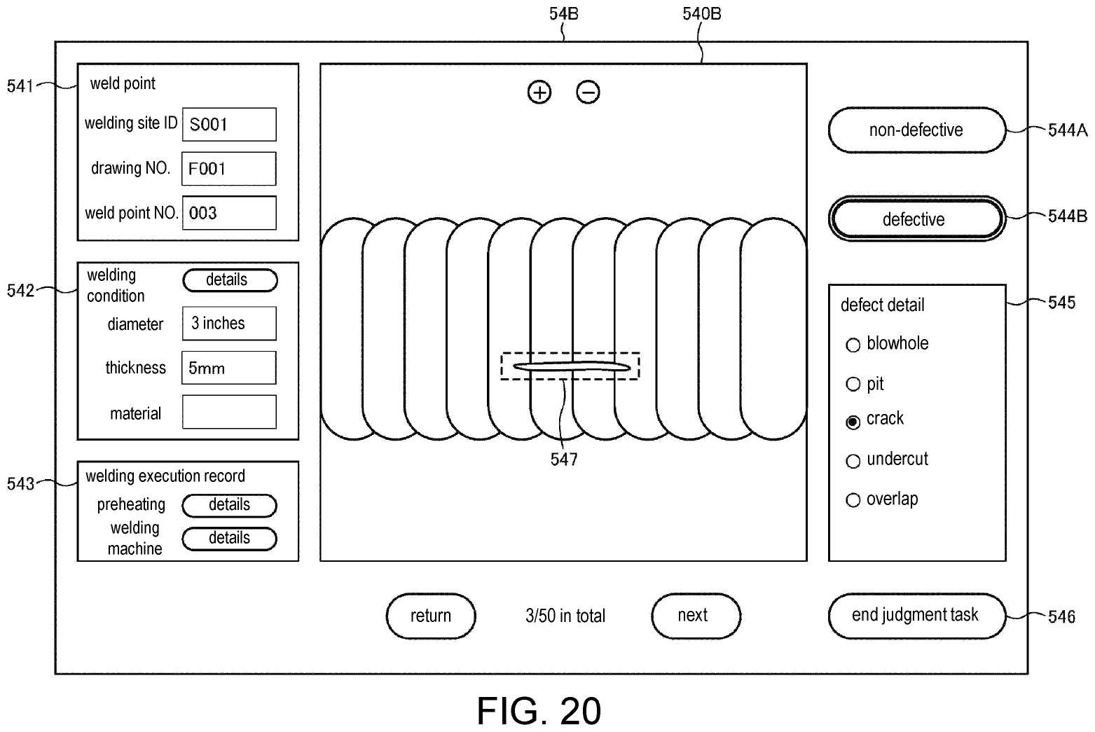

FIG. 20 is a diagram of an example of the judgment result input screen 54B including defect inference data by defect inference processing. The judgment result input screen 54B has an image display region 540B that displays inference result data indicating an inference result obtained by inference of whether there is a weld defect for image data of a judged weld point 11a by the defect inference module 204E, to be superimposed on the image data. On the judgment result input screen 54B illustrated in FIG. 20, a defect occurrence mark 547 is displayed at a position at which a defect “crack” is inferred as being present as the inference result. The other display contents are the same as those of the judgment result input screen 54A illustrated in FIG. 15. In the case in which a judgment result different from the inference result is input by the contractor 50a, the machine learning module 204D may use a learning data pair formed by the image data and defect judgment data indicating the judgment result for re-training of the learning model 25.

As described above, the machine learning module 204D causes the learning model 25 to learn a correlation between image data and the presence or absence of a weld defect by machine learning, and the defect inference module 204E uses the learning model 25. Thus, it is inferred whether there is a weld defect with respect to image data at a judged weld point 11a. When the result of inference of whether there is a weld defect is displayed on, for example, the judgment result input screen 54B, the judge 50 can use the inference result as reference information for judging whether there is a weld defect. Therefore, the inspection quality can be improved.

(5) Analysis of Judgment Match Tendency

Based on the defect inference data registered in the first database 31 and the judge ID and the defect judgment data finally judged by the judge which are registered in the third database 33, the judgment match analysis module 204F transmits the data finally judged by the judge to the machine learning module 204D as a ground truth when the defect inference data and the data finally judged are different from each other. The machine learning module 204D is trained again by using the data to improve the accuracy of the defect inference module 204E. Further, the judgment match analysis module 204F performs judgment match analysis processing of analyzing a judgment match tendency that shows a tendency of match between defect inference data and defect judgment data with respect to the judge 50 as an analysis axis. At this time, the judgment match analysis module 204F receives a predetermined analysis condition and performs statistical processing under the analysis condition, to thereby analyze the judgment match tendency.

A statistical index value representing the judgment match tendency may be calculated as a match ratio of the defect judgment data with respect to the defect inference data as a reference, or as a match ratio of the defect inference data with respect to the defect judgment data as a reference.

As the analysis condition, an analysis target range and an analysis axis, for example, are specified in addition to the statistical index value described above. Specifying the analysis target range and the analysis axis is performed in the same manner as that in analysis of the defect judgment tendency, and therefore the description thereof is omitted.

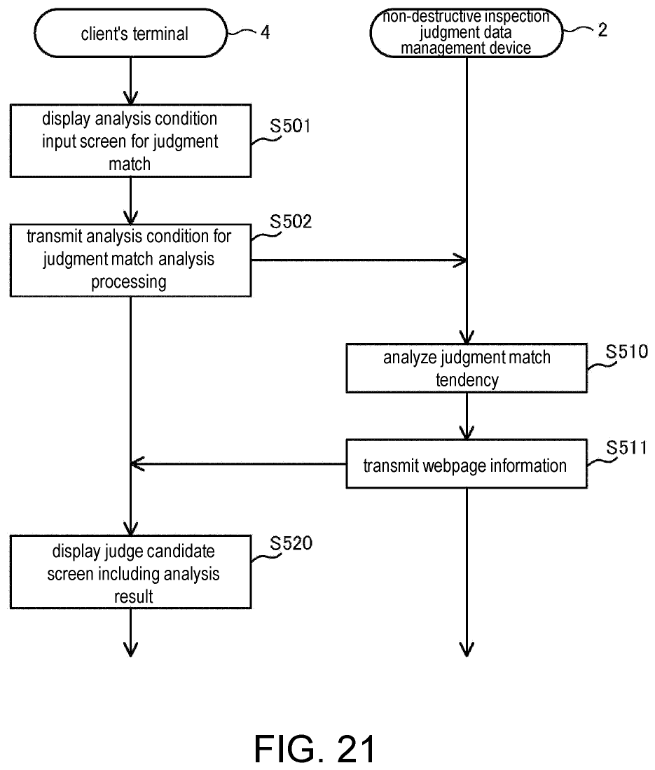

FIG. 21 is a flowchart of an example of judgment match analysis processing. FIG. 21 shows an operation performed when the judgment match analyze button 447 on the judge candidate screen 44A (see FIG. 10) displayed in Step S120 of FIG. 8 is pressed, and the judgment match analysis module 204F receives an analysis condition in the judgment match analysis processing from the client's terminal 4 and analyzes the judgment match tendency under that analysis condition.

First, in Step S501, when the client 40 performs an input operation of pressing the judgment match analyze button 447 on the judge candidate screen 44A (see FIG. 10), the client's terminal 4 displays an analysis condition input screen 46 based on the input operation.

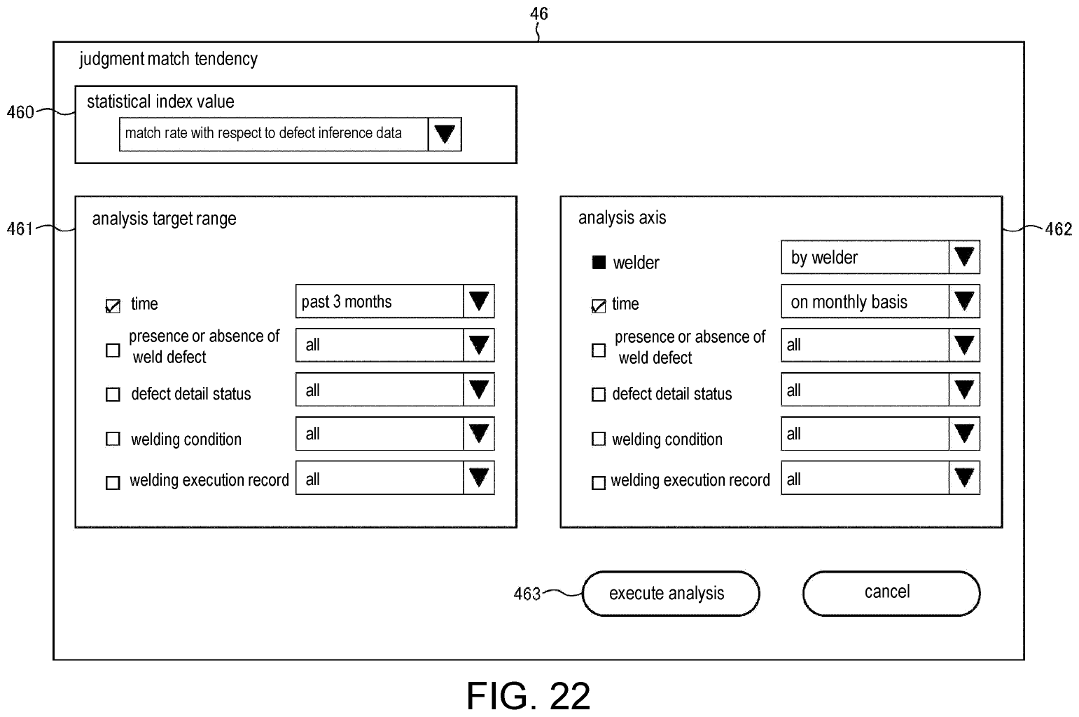

FIG. 22 is a diagram of an example of the analysis condition input screen 46. The analysis condition input screen 46 includes input fields 460 to 462 for specifying an analysis condition used when the judgment match analysis module 204F analyzes a judgment match tendency and an analysis execute button 463 for instructing analysis of the judgment match tendency. In the analysis condition input screen 46 illustrated in FIG. 22, “match rate with respect to defect inference data” is specified in the statistical index value input field 460, “past 3 months” is specified in the analysis target range input field 461, and “on a monthly basis” is specified in addition to “by judge” in the analysis axis input field 462.

Next, in Step S502, when the client 40 specifies the analysis condition in the input fields 460 to 462 on the analysis condition input screen 46 and performs an input operation of pressing the analysis execute button 463, the client's terminal 4 transmits the analysis condition for the judgment match analysis processing based on the input operation to the non-destructive inspection judgment data management device 2. Then, the judgment match analysis module 204F analyzes the judgment match tendency under the analysis condition in Step S510, and the contract support module 205 transmits a webpage for displaying the analysis result of the judgment match tendency to the client's terminal 4 in Step S511. Then, in Step S520, the client's terminal 4 displays a judge candidate screen 44B based on the webpage information.

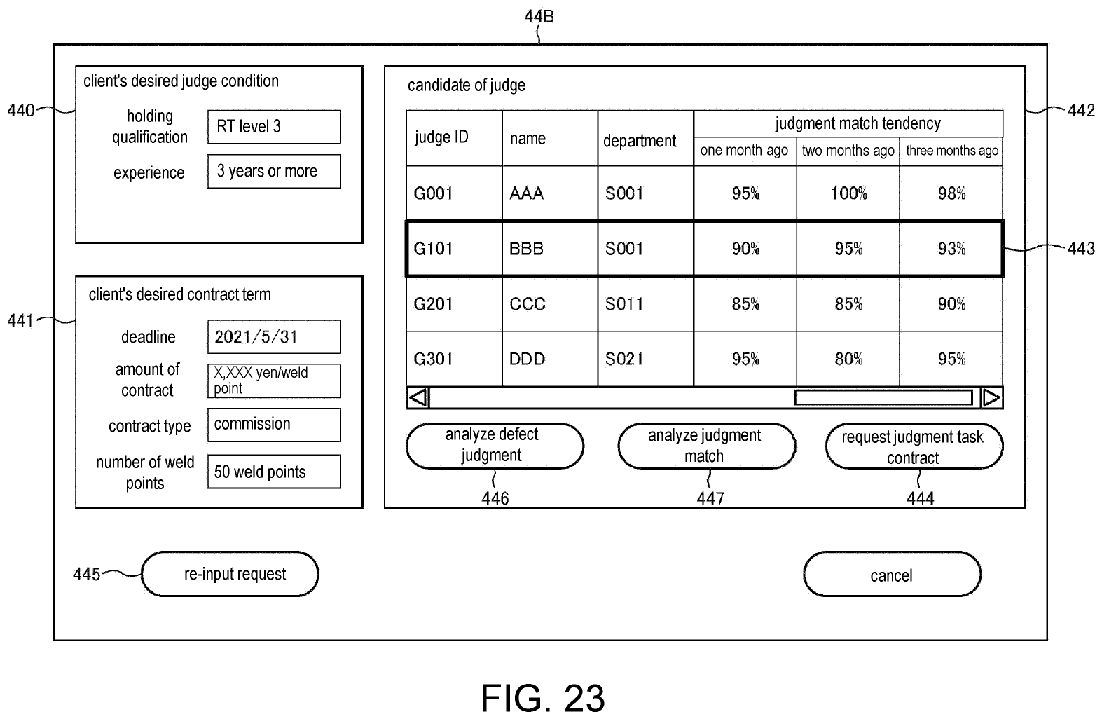

FIG. 23 is a diagram of an example of the judge candidate screen 44B including the analysis result of the judgment match tendency by the judgment match analysis processing. The judge candidate screen 44B has a display field 442 that displays the analysis result of the judgment match tendency by the judgment match analysis module 204F for each candidate of judge 50 extracted by the judge extraction module 204A. The other display contents are the same as those of the judge candidate screen 44A illustrated in FIG. 10.

The judge candidate screen 44B illustrated in FIG. 23 is a screen displayed in the case in which the analysis condition is specified as illustrated in FIG. 22. Therefore, the result of calculation of “match rate with respect to defect inference data” is displayed in a tabular form using two analysis axes of “by judge” and “on a monthly basis” in the display field 442. The judge candidate screen 44B may display the result of analysis by the judgment match analysis module 204F in a predetermined chart format (for example, a pie chart, a bar chart, or a line graph) in place of a tabular form. Moreover, when the judgment match analyze button 447 is pressed and the analysis condition is changed, the judge candidate screen 44B may display an analysis result based on the changed analysis condition. When the client 40 presses the judgment task contract request button 444 on the judge candidate screen 44B, the client's terminal 4 advances the process to Step S121 of FIG. 8, as in the case of the judge candidate screen 44A illustrated in FIG. 10. Therefore, the description is omitted after Step S121.

As described above, the judgment match analysis module 204F analyzes a judgment match tendency based on information registered in the first database 31 and the third database 33. When the analysis result of the judgment match tendency is displayed on, for example, the judge candidate screen 44B, the client 40 can use the analysis result as reference information for selecting the judge 50 to whom the client 40 requests a judgment task.

### OTHER EMBODIMENTS

The present invention is not limited to the above-mentioned embodiment, and various modifications can be made without departing from the gist of the present invention. Further, all of the embodiments thus obtained are included in the technical idea of the present invention.

For example, the data processing module 204 has been described as including the modules 204A to 202F in the above-mentioned embodiment, as illustrated in FIG. 5. However, the data processing module 204 may include only a part of the modules 204A to 202F. In addition, in the flowcharts for illustrating the processing executed by the modules 204A to 204F of the data processing module 204, the execution order of steps may be appropriately changed, or a part of the steps may be omitted.

Moreover, the image data has been described as being generated by the inspection machine 7 in the above-mentioned embodiment. Alternatively, the image data may be generated by scanning a film on which radiation transmitted through a weld point 11 is imaged with an image reading device such as a scanner, or may be a CR image.

Moreover, contract information has been described as being generated by the contract support module 205 of the non-destructive inspection judgment data management device 2 in the contract support processing illustrated in FIG. 7 and FIG. 8 in the above-mentioned embodiment. Alternatively, the contract information may be generated by, for example, a device or system other than the non-destructive inspection judgment data management device 2, or may be information generated by another method as long as the contract information indicates that a contract for a judgment task has been established.

Moreover, the judgment task has been described as being undertaken by one judge 50 in the above-mentioned embodiment. Alternatively, the judgment task may be undertaken by a plurality of judges or by a business party to which the judge 50 belongs. In this case, the judge extraction module 204A may receive, for example, the desired number of judges 50 as the client's desired judge condition and extract candidates of judge 50 or the business party (the department) so as to meet the desired number. Further, working hours of the judges 50 are not required to be the same. The candidates of judge 50 or the business party (the department) may be extracted in such a manner that 24 hours can be used effectively.

Further, the judge extraction module 204A has been described as receiving the holding qualification and the experience as the client's desired judge condition in the above-mentioned embodiment, as illustrated in the input field 430 of the judgment task request screen 43 of FIG. 9. Alternatively, the judge extraction module 204A may receive the defect judgment tendency or the judgment match tendency as the client's desired judge condition and extract candidates of judge 50 matching the defect judgment tendency or judgment match tendency thus received.

Further, the contract support module 205 has been described as transmitting the notification of judgment task contract request to the judge 50 selected by the client 40 among the candidates of judge 50 extracted by the judge extraction module 204A in Step S122 of FIG. 8 in the above-mentioned embodiment. Alternatively, the contract support module 205 may omit transmission of the webpage information in Step S115, select, for example, the best match judge 50 who matches the client's desired judge condition and the client's desired contract term among the candidates of judge 50 extracted by the judge extraction module 204A, and transmit the notification of judgment task contract request to the selected judge 50.

Further, the defect judgment tendency by the defect judgment analysis module 204C and the judgment match tendency by the judgment match analysis module 204F have been described as reference information for selection of the judge 50 of whom the judgment task is requested in the above-mentioned embodiment. Alternatively, examples of evaluation item for evaluating the judge 50 which can be used as the above-mentioned reference information include an evaluation item related to the judgment task quality, an evaluation item related to the judgment task productivity, and an evaluation item related to the feedback from the client 40 of a judgment task. Information required for each evaluation item may be registered in the first to third databases 31 to 33 as appropriate, and the data processing module 204 may include a judge evaluation module that evaluates the judge 50 based on any of the above-mentioned evaluation items.

The evaluation item related to the judgment task quality is based on a ratio of match between the result of judgment by the judge 50 and at least one of the result of judgment by a contractor or a prime contractor when double-checking or triple-checking is performed by the client 40 (the contractor or the prime contractor) with respect to the result of judgment by the judge 50 indicated by the defect judgment data, for example. The evaluation item related to the judgment task productivity is based on, for example, the total number of the judged weld points 11a related to judgment tasks that have not been executed yet (the number of backlogs), a margin time period from the judgment time and date at which a judgment task has been performed to a deadline of the judgment task, or a compliance rate of the judgment task deadline. The evaluation item related to the feedback is based on a positive or negative feedback input by the client 40 in an input field provided for allowing input of a feedback to the judge 50 (for example, a comment field or five-level evaluation) in the judgment result confirmation screen 45, for example. In the case in which the client 40 is a contractor, a feedback by a prime contractor may be acquired via another system constructed by the contractor and the prime contractor, and the evaluation item related to the feedback may be based on the feedback by the prime contractor.

### REFERENCE SIGNS LIST

1 . . . non-destructive inspection judgment task management system, 2 . . . non-destructive inspection judgment data management device, 3 . . . database device, 4 . . . client's terminal, 5 . . . judge's terminal, 6 . . . welding machine, 7 . . . inspection machine, 8 . . . communication network, 10 . . . welding site, 11 . . . weld point, 11a . . . judged weld point, 20 . . . control unit, 21 . . . memory unit, 22 . . . communication unit, 23 . . . input unit, 24 . . . display unit, 25 . . . learning model, 31 . . . first database, 32 . . . second database, 32A . . . client table, 32B . . . judge table, 32C . . . judgment task table, 33 . . . third database, 40 . . . client, 41 . . . process execution record storage unit, 42 . . . contract information storage unit, 43 . . . judgment task request screen, 44A, 44B . . . judge candidate screen, 45 . . . judgment result confirmation screen, 46 . . . analysis condition input screen, 50 . . . judge, 50a . . . contractor, 51 . . . contract information storage unit, 52 . . . judgment task contract request screen, 53 . . . judgment task start screen, 54A, 54B . . . judgment result input screen, 201 . . . first database registration module, 202 . . . second database registration module, 203 . . . third database registration module, 204 . . . data processing module, 204A . . . judge extraction module, 204B . . . access control module, 204C . . . defect judgment analysis module, 204D . . . machine learning module, 204E . . . defect inference module, 204F . . . judgment match analysis module, 205 . . . contract support module, 206 . . . judgment task support module, 210 . . . welding data management program, 900 . . . computer

1. A non-destructive inspection judgment data management device, comprising:
a first database registration module configured to register image data related to a non-destructive inspection of a weld point in a first database;
a second database registration module configured to register judge information on a judge undertaking a judgment task of judging whether a weld defect is present at the weld point based on the image data, in a second database; and
an access control module configured to allow, based on contract information indicating that a contract for the judgment task has been established with the judge selected as a contractor of the judgment task among the judges registered in the second database, the contractor to access the image data related to the judgment task in the image data registered in the first database via Internet.

2. The non-destructive inspection judgment data management device according to claim 1,
wherein the second database registration module is configured to register, as the judge information, a judge profile including at least a holding qualification of the judge in the second database, and
wherein the non-destructive inspection judgment data management device further comprises a judge extraction module configured to receive a client's desired judge condition desired as the judge profile by a client of the judgment task and to extract the judge matching the client's desired judge condition among the judges registered in the second database.

3. The non-destructive inspection judgment data management device according to claim 2,
wherein the second database registration module is configured to register a judge's desired contract term desired as a term of the contract by the judge in the second database as the judge information, and
wherein the judge extraction module is configured to receive a client's desired contract term desired as a term of the contract by the client and to extract the judge matching the client's desired contract term among the judges registered in the second database.

4. The non-destructive inspection judgment data management device according to claim 1,
wherein the first database registration module is configured to register a welding condition at the weld point in the first database in association with the weld point, and
wherein the access control module is configured to allow the contractor to access the image data and the welding condition related to the judgment task in the image data and the welding condition registered in the first database via the Internet based on the contract information.

5. The non-destructive inspection judgment data management device according to claim 1, further comprising a third database registration module configured to receive defect judgment data indicating a result of judgment of whether the weld defect is present at the weld point based on the image data related to the judgment task from the contractor via the Internet and to register the defect judgment data in a third database in association with the weld point,
wherein the access control module is configured to allow the client of the judgment task to access the defect judgment data related to the judgment task in the defect judgment data registered in the third database via the Internet based on the contract information.

6. The non-destructive inspection judgment data management device according to claim 5,
wherein the third database registration module is configured to register judge identification information for identifying the judge as the contractor who has judged whether the weld defect is present at the weld point in the third database in association with the weld point, and
wherein the non-destructive inspection judgment data management device further comprises a defect judgment analysis module configured to analyze, based on the judge identification information and the defect judgment data registered in the third database, a defect judgment tendency indicating a tendency at a time when the judge has judged whether the weld defect is present, with respect to the judge as an analysis axis.

7. The non-destructive inspection judgment data management device according to claim 5, further comprising a machine learning module configured to form a learning data pair including the image data registered in the first database as input data and the defect judgment data registered in the third database for the image data as training data, and to input a plurality of the learning data pairs to a learning model to cause the learning model to learn a correlation between the input data and the training data by machine learning.

8. The non-destructive inspection judgment data management device according to claim 7, further comprising a defect inference module configured to infer whether the weld defect is present at the weld point as an inference target by inputting the image data of the weld point to the learning model as the input data.

9. The non-destructive inspection judgment data management device according to claim 8,
wherein the first database registration module is configured to register defect inference data indicating a result of inference of whether the weld defect is present at the weld point by the defect inference module in the first database in association with the weld point, and
wherein the access control module is configured to allow the contractor to access the image data and the defect inference data related to the judgment task in the image data and the defect inference data registered in the first database via the Internet based on the contract information.

10. The non-destructive inspection judgment data management device according to claim 8,
wherein the first database registration module is configured to register defect inference data indicating a result of inference of whether the weld defect is present at the weld point by the defect inference module in the first database in association with the weld point,
wherein the third database registration module is configured to register judge identification information for identifying the judge as the contractor who has judged whether the weld defect is present at the weld point in the third database in association with the weld point, and
wherein the non-destructive inspection judgment data management device further comprises a judgment match analysis module configured to analyze, based on the defect inference data registered in the first database and the judge identification information and the defect judgment data registered in the third database, a judgment match tendency indicating a tendency of match between the defect inference data and the defect judgment data with respect to the judge as an analysis axis.

11. A non-destructive inspection judgment data management method, comprising:
a first database registration step of registering image data related to a non-destructive inspection of a weld point in a first database;
a second database registration step of registering judge information on a judge undertaking a judgment task of judging whether a weld defect is present at the weld point based on the image data, in a second database; and
an access control step of allowing, based on contract information indicating that a contract for the judgment task has been established with the judge selected as a contractor of the judgment task among the judges registered in the second database, the contractor to access the image data related to the judgment task in the image data registered in the first database via Internet.

12. The non-destructive inspection judgment data management device according to claim 2,
wherein the first database registration module is configured to register a welding condition at the weld point in the first database in association with the weld point, and
wherein the access control module is configured to allow the contractor to access the image data and the welding condition related to the judgment task in the image data and the welding condition registered in the first database via the Internet based on the contract information.

13. The non-destructive inspection judgment data management device according to claim 3,
wherein the first database registration module is configured to register a welding condition at the weld point in the first database in association with the weld point, and
wherein the access control module is configured to allow the contractor to access the image data and the welding condition related to the judgment task in the image data and the welding condition registered in the first database via the Internet based on the contract information.

14. The non-destructive inspection judgment data management device according to claim 2, further comprising a third database registration module configured to receive defect judgment data indicating a result of judgment of whether the weld defect is present at the weld point based on the image data related to the judgment task from the contractor via the Internet and to register the defect judgment data in a third database in association with the weld point,
wherein the access control module is configured to allow the client of the judgment task to access the defect judgment data related to the judgment task in the defect judgment data registered in the third database via the Internet based on the contract information.

15. The non-destructive inspection judgment data management device according to claim 3, further comprising a third database registration module configured to receive defect judgment data indicating a result of judgment of whether the weld defect is present at the weld point based on the image data related to the judgment task from the contractor via the Internet and to register the defect judgment data in a third database in association with the weld point,
wherein the access control module is configured to allow the client of the judgment task to access the defect judgment data related to the judgment task in the defect judgment data registered in the third database via the Internet based on the contract information.

16. The non-destructive inspection judgment data management device according to claim 4, further comprising a third database registration module configured to receive defect judgment data indicating a result of judgment of whether the weld defect is present at the weld point based on the image data related to the judgment task from the contractor via the Internet and to register the defect judgment data in a third database in association with the weld point,
wherein the access control module is configured to allow the client of the judgment task to access the defect judgment data related to the judgment task in the defect judgment data registered in the third database via the Internet based on the contract information.

17. The non-destructive inspection judgment data management device according to claim 12, further comprising a third database registration module configured to receive defect judgment data indicating a result of judgment of whether the weld defect is present at the weld point based on the image data related to the judgment task from the contractor via the Internet and to register the defect judgment data in a third database in association with the weld point,
wherein the access control module is configured to allow the client of the judgment task to access the defect judgment data related to the judgment task in the defect judgment data registered in the third database via the Internet based on the contract information.

18. The non-destructive inspection judgment data management device according to claim 13, further comprising a third database registration module configured to receive defect judgment data indicating a result of judgment of whether the weld defect is present at the weld point based on the image data related to the judgment task from the contractor via the Internet and to register the defect judgment data in a third database in association with the weld point,
wherein the access control module is configured to allow the client of the judgment task to access the defect judgment data related to the judgment task in the defect judgment data registered in the third database via the Internet based on the contract information.

19. The non-destructive inspection judgment data management device according to claim 6, further comprising a machine learning module configured to form a learning data pair including the image data registered in the first database as input data and the defect judgment data registered in the third database for the image data as training data, and to input a plurality of the learning data pairs to a learning model to cause the learning model to learn a correlation between the input data and the training data by machine learning.

20. The non-destructive inspection judgment data management device according to claim 9,
wherein the first database registration module is configured to register defect inference data indicating a result of inference of whether the weld defect is present at the weld point by the defect inference module in the first database in association with the weld point,
wherein the third database registration module is configured to register judge identification information for identifying the judge as the contractor who has judged whether the weld defect is present at the weld point in the third database in association with the weld point, and
wherein the non-destructive inspection judgment data management device further comprises a judgment match analysis module configured to analyze, based on the defect inference data registered in the first database and the judge identification information and the defect judgment data registered in the third database, a judgment match tendency indicating a tendency of match between the defect inference data and the defect judgment data with respect to the judge as an analysis axis.
